(19) United States
(12) Patent Application Publication
(10) Pub. No.: US 2009/0326924 A1
(43) Pub. Date: Dec. 31, 2009

(54) Projecting Semantic Information from a Language Independent Syntactic Model

(75) Inventors: Anthony L. Crider, Mill Creek, WA (US); Jonathan V. Ziebell, Trabuco Canyon, CA (US); Nghi H. Nguyen, Garden Grove, CA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/335,065

(22) Filed: Dec. 15, 2008

Related U.S. Application Data
(60) Provisional application No. 61/076,356, filed on Jun. 27, 2008.

(51) Int. Cl. G10L 15/18

(52) U.S. Cl. 704/9; 704/E15.018

(57) ABSTRACT

Embodiments for the conversion of Computational Independent Model (CIM) rule expressions into semantically non-ambiguous syntax trees are disclosed. In accordance with one embodiment, a method includes analyzing a sentential structure of a Computational Independent Model (CIM) rule expression for clauses. The clauses include at least one expression and at least one rule. The method further includes constructing a semantically non-ambiguous LF syntax tree from the CIM rule expression. The construction being implemented using a logical form (LF) model.

### CROSS REFERENCE TO RELATED APPLICATIONS

This application claims priority to U.S. Provisional Patent Application No. 61/076,356 to Crider et al., entitled “Projecting Semantic Information From a Language Independent Syntactic Model”, filed on Jun. 27, 2008, and incorporated herein by reference. This application is related to concurrently-filed U.S. patent application Ser. No. ______ (Attorney Docket No. MS1-3799US), entitled “Projecting Syntactic Information Using a Bottom-Up Pattern Matching Algorithm,” which is incorporated herein by reference.

### BACKGROUND

Natural language used by humans to communicate tends to be contextual and imprecise. In the area of computer programming, a Computational Independent Model (CIM) may be used to convert the requirements for a computer application, as expressed in natural language, to language neutral rule expressions. The CIM language neutral rule expressions are generally non-ambiguous in their meaning. The language neutral expressions may then act the “blueprint” for the generation of computer code. For example, code generation software may be used to automatically generate computer code based on the “blueprint.” However, in some instances, the CIM in which the language neutral rule expressions are stored is not sufficient to render a semantically non-ambiguous “blueprint.” In turn, a semantically ambiguous “blueprint” may result in the generation of a computer application that contains logical errors.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Described herein are embodiments of various technologies for implementing a Logical Form (LF) model that converts Computational Independent Model (CIM) rule expressions into semantically non-ambiguous syntax trees. Code generation software may then process these semantically non-ambiguous syntax trees, which make the “blueprint” of a program, into a computer application. In one embodiment, a method includes analyzing a sentential structure of a Computational Independent Model (CIM) rule expression for clauses. The clauses include at least one expression and at least one rule. The method further includes constructing a semantically non-ambiguous LF syntax tree from the CIM rule expression. The construction being implemented using a logical form (LF) model. Other embodiments will become more apparent from the following detailed description when taken in conjunction with the accompanying drawings.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a block diagram illustrating exemplary components of a logical form (LF) transformer for converting a Computational Independent Model (CIM) rule expression into a semantically non-ambiguous syntax tree using a Logical Form (LF) model, in accordance with various embodiments.

FIG. 2 is a block diagram illustrating the selected components of a Logical Form (LF) model, in accordance with various embodiments.

FIG. 3 is a block diagram illustrating the various components of a Logical Form (LF) model, in accordance with various embodiments.

FIG. 4 is a block diagram illustrating the various components of an Aggregate Phrase Marker that inherits from a Phrase Marker component in a Logical Form (LF) model, in accordance with various embodiments.

FIG. 5 is a block diagram illustrating the various components of an Event Phrase Marker that inherits from a Phrase Marker component in a Logical Form (LF) model, in accordance with various embodiments.

FIG. 6 is a block diagram illustrating the various components of an Existence Phrase Marker that inherits from a Phrase Marker component in a Logical Form (LF) model, in accordance with various embodiments.

FIG. 7 is a block diagram illustrating the various components of a Quantifier component in a Logical Form (LF) model, in accordance with various embodiments.

FIG. 8 is a flow diagram illustrating an exemplary process for converting a Computational Independent Model (CIM) rule expression into a semantically non-ambiguous syntax tree based on a Logical Form (LF) model, in accordance with various embodiments.

FIG. 9 is a flow diagram illustrating an exemplary process for transforming a Computational Independent Model (CIM) rule expression in accordance with various embodiments.

FIG. 10 is a flow diagram illustrating an exemplary process for processing an assertion in a Computational Independent Model (CIM) rule expression in accordance with various embodiments.

FIG. 11 is a flow diagram illustrating an exemplary process for processing a constraint in a Computational Independent Model (CIM) rule expression in accordance with various embodiments.

FIG. 12 is a flow diagram illustrating an exemplary process for processing a declaration in a Computational Independent Model (CIM) rule expression in accordance with various embodiments.

FIG. 13 is a flow diagram illustrating an exemplary process for processing a default rule in a Computational Independent Model (CIM) rule expression in accordance with various embodiments.

FIG. 14 is a flow diagram illustrating an exemplary process for processing a fact expression in a Computational Independent Model (CIM) rule expression in accordance with various embodiments.

FIG. 15 is a flow diagram illustrating an exemplary process for processing a binary logical expression in a Computational Independent Model (CIM) rule expression in accordance with various embodiments.

FIG. 16 is a flow diagram illustrating an exemplary process for processing a sentence expression in a Computational Independent Model (CIM) rule in accordance with various embodiments.

FIG. 17 is a flow diagram illustrating an exemplary process for processing value expressions in a Computational Independent Model (CIM) rule in accordance with various embodiments.

FIG. 18 is a flow diagram illustrating an exemplary process for processing a role expression in a Computational Independent Model (CIM) rule expression using an expression (or a role expression) in accordance with various embodiments.

FIG. 19 is a block diagram illustrating a representative computing device. The representative computing device may be used to implement a Logical Form (LF) model, in accordance with various embodiments.

### DETAILED DESCRIPTION

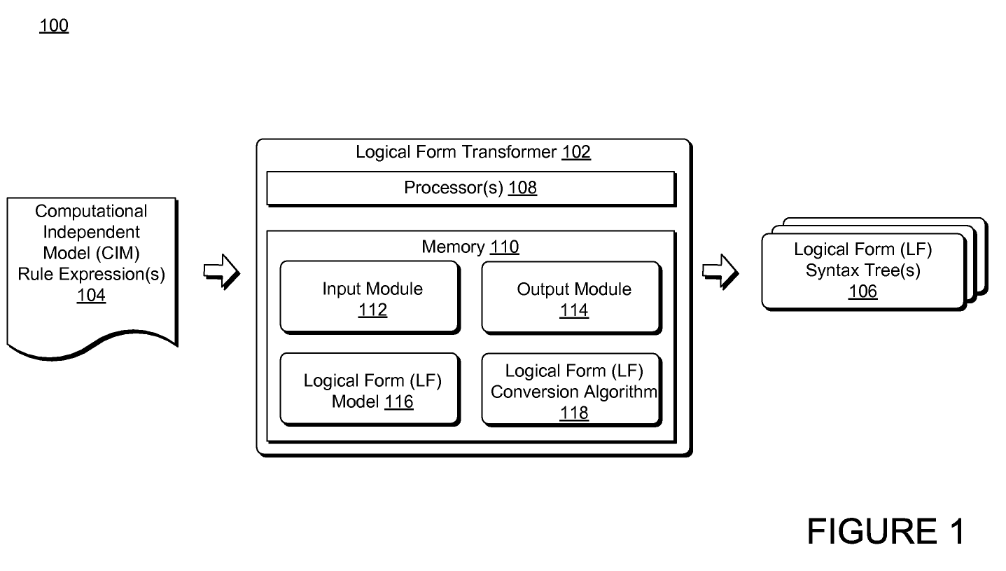

This disclosure is directed to embodiments that facilitate the conversion of Computational Independent Model (CIM) rule expressions into semantically non-ambiguous syntax trees. The semantically non-ambiguous syntax trees may be further process by a code generation program to produce computer applications. Specifically, the embodiments described herein are directed to using a Logical Form (LF) model to provide the non-ambiguous syntax trees from natural language expressions. The LF model may be configured to resolve the anaphoric references within the surface syntax of a natural language expression so that a corresponding non-ambiguous syntax tree may be produced. In this way, the use of the LF model may improve the ability of code generation programs to produce error-free computer applications from natural language expressions. Various examples of LF model usage to produce semantically non-ambiguous syntax trees are described below with reference to FIGS. 1-19.

### Exemplary Conversion Concept

FIG. 1 is a block diagram 100 illustrating exemplary components of a logical form (LF) transformer 102. The LF transformer 102 may be configured to convert one or more Computational Independent Model (CIM) rule expression 104 into one or more corresponding semantically non-ambiguous syntax trees 106. The one or more CIM rule expressions 104 may store natural language expressions. Natural language expressions are expressions that are spoken or written by humans for general-purpose communication. On the other hand, CIM rule expressions 104 are formal language rule expressions that are based on structured syntax. Accordingly, while the meanings of natural language expressions may be dependent on the context in which the expressions are presented, the meaning of CIM rule expressions are generally not ambiguous. Accordingly, in the field of information technology, CIM rule expressions, also referred to as business rules, may be written by business professionals as “blueprints” for developing software applications.

In some instances, software translators have been developed to automatically generate computer code based on CIM rule expressions. For example, such methods are disclosed in commonly owned U.S. Publication No. 2005/0256371, filed on Apr. 30, 2004, entitled “Generating Programmatic Interfaces from Natural Language Expressions of Authorizations for Request of Information,” commonly owned U.S. Patent Publication No. 2005/0246157, filed on Apr. 30, 2004, entitled “Generating Programmatic Interfaces from Natural Language Expressions of Authorization for Provision of Information,” and commonly owned U.S. Publication No. 2006/0026576, filed on Feb. 2, 2006, entitled “Generating a Database Model from Natural Language Expressions of Business Rules,” the contents of which are herein incorporated by reference.

Thus, according to various embodiments, the one or more semantically non-ambiguous LF syntax trees 106 may act as intermediate representations during the automatic translation of CIM rule expression to software code. In other words, the CIM rules expressions may be first converted into corresponding Semantically non-ambiguous LF syntax trees 106. Subsequently, a software translator may transform the semantically non-ambiguous LF syntax trees 106 into software code.

As described above, The LF transformer 102 may be configured to convert one or more Computational Independent Model (CIM) rule expression 104 into one or more corresponding semantically non-ambiguous syntax trees 106. The LF Transformer 102 may include one or more processors 108 and a memory 110. The memory 110 may include volatile and/or nonvolatile memory, removable and non-removable media implemented in any method or technology for storage of information, such as computer-readable instructions, data structures, program modules or other data. Such memory may include, but is not limited to, random access memory (RAM), read-only memory (ROM), Electrically erasable programmable read-only Memory (EEPROM), flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and is accessible by a computer system.

The memory 110 of the LF transformer 102 may store an input module 112, an output module 114, a LF model 116, and a LF conversion algorithm 118. The input module 112 may be configured to receive one or more CIM rule expressions 104 into the LF transformer 102. By example, but not limitation, the input module 112 may receive the rule expression from a data storage that contains the CIM rule expressions 104, or a CIM rule expression generator (not shown) that produces the CIM rule expressions 104 from natural language expressions.

The LF model 116 may serve as a structural scheme for the generation of the semantically non-ambiguous LF syntax trees 106 from the CIM rules expressions 104. Accordingly, the LF conversion algorithm 118 may use the LF model 116 to convert each of the CIM rule expressions 104 into a semantically non-ambiguous LF syntax tree 106 by performing various processes. The output module 114 may be configured to present the semantically non-ambiguous LF syntax trees 106 to another mechanism. By example, but not limitation, the output module 114 may present the semantically non-ambiguous LF syntax trees 106 to translator software that process the semantically non-ambiguous LF syntax trees 106 into computer code. In other non-limiting examples, the output module 114 may be configured to present the LF syntax tress 106 on a display device for viewing, or for storage in a database.

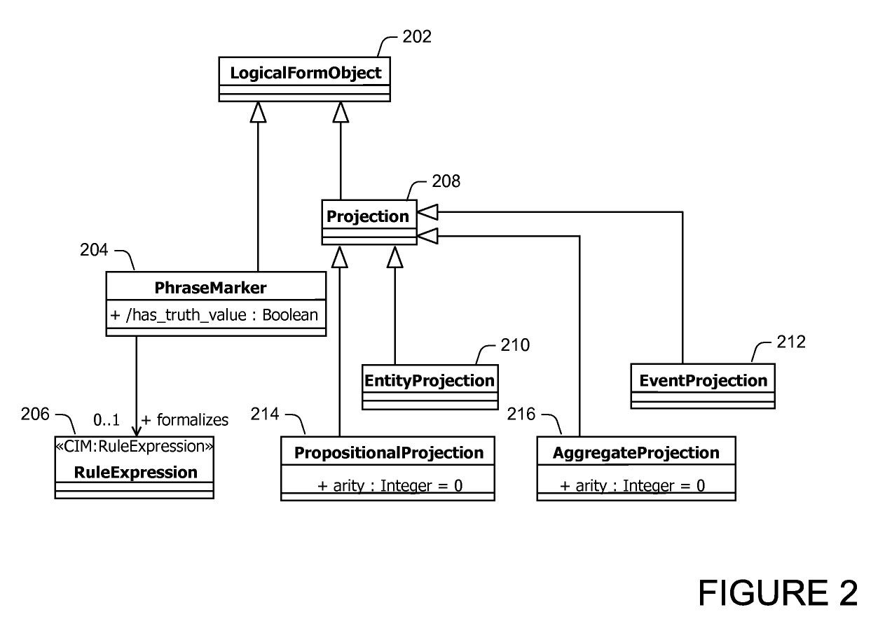

FIG. 2 is a block diagram illustrating the various components of a Logical Form (LF) model 116, in accordance with various embodiments. The LF Model 116 includes a LogicalFormObject 202. In various embodiments, the LogicalFormObject 202 provides a semantically non-ambiguous LF syntax tree 106 that is derived from a CIM rule expression.

### Phrase Markers

In turn, the LogicalFormObject 202 includes a PhraseMarker 204. The PhraseMarker 204 encodes the sentential logical structure of the semantically non-ambiguous LF syntax tree. The PhraseMarker 204 is either a sentential Phrase Marker (one that is either true or false), or a projection PhraseMarker (one that is a set comprised of n-tuple entities). More specifically, in computational terms, the sentential PhraseMarker 204 may be determined to be true or false via a yes-no interrogation. Alternatively, a state of affairs can be contrived that would make the sentential PhraseMarker 204 true or false. In such an instance, new information may be declared. Following the determination, the sentential PhraseMarker 204 is then asserted. On the other hand, a projection PhraseMarker 204 is computed as the collection of n-tuple entities that satisfy a specified relation (n-ary function) or characteristic (unary function).

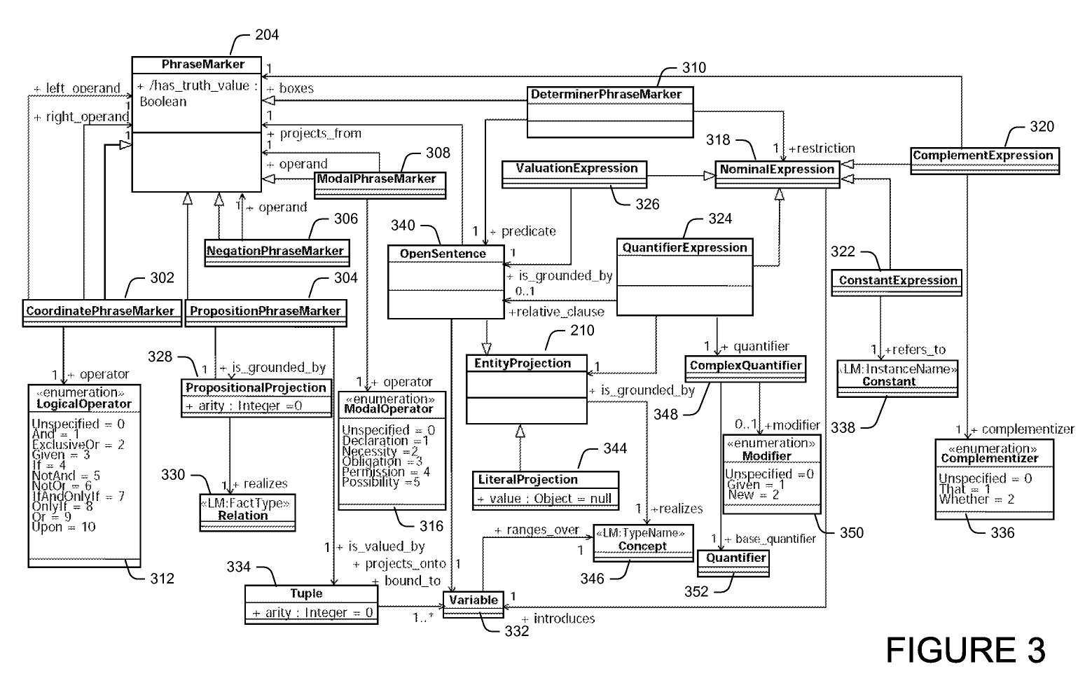

Further, the base class for the PhraseMarker 204 shown in FIG. 2 is abstract. The Phrase Marker 204 includes a has_truth_value property that is used to indicate whether an instance of the Phrase Marker 204 is a sentential PhraseMarker 202 or a projection PhraseMarker 204. As further illustrated in FIG. 2, the PhraseMarker 204 may formalize Computationally Independent Model (CIM) Rule expressions 206. Moreover, additional phrase marker components are derived from the PhraseMarker 204. These additional phrase marker components are illustrated in FIG. 3.

FIG. 3 illustrates is a block diagram illustrating various components of the of a Logical Form (LF) model, in accordance with various embodiments. Specifically, FIG. 3 illustrates additional phrase marker components that are derived from the PhraseMarker 204. These phrase marker components include a CoordinatePhraseMarker 302, a PropositionPhraseMarker 304, a NegationPhraseMarker 306, a ModalPhraseMarker 308, and a DeterminerPhraseMarker 310.

The CoordinatePhraseMarker 302 enables logical coordination between sentential objects. In this role, the CoordinatePhraseMarker 302 is a form of the sentential PhraseMarker 204, and inherits from PhraseMarker 204. The CoordinatePhraseMarker 302 includes a left_operand property and a right_operand property. The left_operand property designates the sentential phrase marker on the left hand side of the logical operation. Likewise, the right_operand property designates the sentential phrase marker on the right hand side of the logical operation.

For logical operators that are non-commutative, the order of the operands is significant. For instance, if the left operand is the logical expression P and the right hand operator is the logical expression Q, then given the operator if, the logical coordination P if Q has a different meaning than Q if P.

Furthermore, the CoordinatePhraseMarker 302 also includes a LogicalOperator property that identifies the type of logical coordination that is to be applied. Accordingly, an LogicalOperator enumeration 312 is included in the CoordinatePhraseMarker 302. The LogicalOperator enumeration 312 is configured to encode the logical operations that is computed between sentential phrase markers. An exemplary list of logical operator values specified by the LogicalOperator enumeration 312 is listed below in Table I. For each of the operators listed in Table I, the order in which the operands are evaluated is crucially defined to be left-to-right, i.e., the truth of the sentential phrase marker of the left_operand property of the embedding CoordinatePhraseMarker 302 must be computed before the truth of the sentential phrase marker of the right_operand property. In order to illustrate the operation of the operators in Table I, a left operand, which corresponds to the left_operand property, may be denoted as l. Similarly, a right operand, which corresponds to the right_operand property, may be denoted as r.

TABLE I
Exemplary Logical Operator Values of the LogicalOperator
Enumeration

| Operator | Computation |
|---|---|
| And | indicates that the logical conjunction will be computed as |
| | [symbol] l, r [symbol] ∈ { [symbol] 1, 1 [symbol] } |
| ExclusiveOr | indicates that logical exclusive disjunction |
| | will be computed as |
| | [symbol] l, r [symbol] ∈ { [symbol] 1, 0 [symbol] [symbol] 0, 1 [symbol] } |
| Given | synonymous with the If value |
| If | indicates that logical left-to-right implication will be |
| | computed as |
| | [symbol] l, r [symbol] ∈ [symbol] 0, 0 [symbol] , [symbol] 0, 1 [symbol] [symbol] 1, 1 [symbol] } |
| IfAndOnlyIf | indicates that logical left-to-right equivalence |
| | will be computed |
| | as [symbol] l, r [symbol] ∈ { [symbol] 0, 0 [symbol] , [symbol] 1, 1 [symbol] } |
| NotAnd | indicates that logical negated conjunction will be |
| | computed as |
| | [symbol] l, r [symbol] ∈ { [symbol] 0, 0 [symbol] , [symbol] 1, 0 [symbol] , [symbol] 0, 1 [symbol] } |
| NotOr | indicates that logical negated non-exclusive disjunction will |
| | be computed as [symbol] l, r [symbol] ∈ { [symbol] 0, 0 [symbol] } |
| OnlyIf | indicates that logical left-to-right implication will |
| | be computed as |
| | [symbol] l, r [symbol] ∈ { [symbol] 0, 0 [symbol] , [symbol] 1, 0 [symbol] , [symbol] 1, 1 [symbol] } |
| Or | indicates that logical non-exclusive disjunction |
| | will be computed |
| | as [symbol] l, r [symbol] ∈ { [symbol] , 0 [symbol] , [symbol] 0, 1 [symbol] , [symbol] 1, 1 [symbol] } |
| Upon | synonymous with the If value |

The PropositionPhraseMarker 304 is a projection phrase marker and is the primary means by which relational information is exposed for computation. The proposition projection designated by an is_grounded_by property refers to a Relation 330. In other words, the is_grounded_by property designates a PropositionProjection that projects a set of n-tuple entities. Thus, the proposition phrase marker projects all of the n-tuple entities that satisfy the relation Relation. The PropositionPhraseMarker 304 furthers include an is_valued_by property. The is_valued_by property designates a Tuple 314 that identifies the variables to which the relation applies.

The NegationPhraseMarker 306 is a sentential phrase marker that expects its only property to also be a sentential phrase marker. The NegationPhraseMarker 306 inherits from PhraseMarker 204. The NegationPhraseMarker 306 includes a property operand, which designates the sentential phrase marker to be negated. In computational terms, a request to value the NegationPhraseMarker 306 is determined to be true just in case its operand is false, and vice versa. A request to assert a NegationPhraseMarker 306 is computed to ensure that the state of its operand is not true.

The ModalPhraseMarker 308 is a sentential phrase marker that expects its operand to also be a sentential phrase marker. The ModalPhraseMarker 308 inherits from PhraseMarker 204. The ModalPhraseMarker 308 includes an operand property and an operator property. The operand property designates the sentential phrase marker to be constrained. The operator property specifies the mode in which the operand is to be considered. In computational terms, a modal sentence is never valued. Instead, a modal sentence serves to constrain the types of knowledge that may be asserted or retracted.

Accordingly, the ModalPhraseMarker 308 includes a ModalOperator enumeration 316 that is configured to convey the mode of the sentence in terms of intensional propositional logic. An exemplary list of operators identified by the ModalOperator enumeration 316 of the ModalPhraseMarker 308 is listed below in Table II. The operators are meant to convey the mode of the sentence in terms of intensional propositional logic.

TABLE II
Exemplary Operators of the Modal Operator Enumeration

| Operator | Mode of Sentence |
|---|---|
| Declaration | indicates that the embedded sentential phrase marker |
| | introduces new knowledge to the universe of discourse, |
| | either by adding or removing n-tuples to a |
| | knowledge base Γ |
| Impossibility | indicates that the embedded sentential phrase marker |
| | must not be true in any possible world |
| Necessary | indicates that the embedded sentential phrase marker |
| | must be true in all possible worlds |
| Obligation | indicates that the embedded sentential phrase marker |
| | ought to be true in all possible worlds, but may not be true |
| | in all possible worlds at the time the discourse containing |
| | the obligation expression is computed |
| Permission | indicates that the embedded sentential phrase marker |
| | may be true in some possible world, but have not have |
| | been possible prior to or may not be possible after the |
| | discourse containing the permission expression is computed |
| Possiblity | indicates that the embedded sentential phrase marker |
| | may be true in some possible world |
| Prohibition | indicates that the embedded sentential phrase marker may |
| | be true in some possible world |

The DeterminerPhraseMarker 310 is a sentential phrase marker corresponding to one of the logical expressions: Qx(R(x)→P(x)) or Qx [symbol] R(x): P(x). The former expression is the traditional predicate calculus formulation. The latter expression (and linguistically preferred) is the typed logic formulation. The DeterminerPhraseMarker 310 inherits from PhraseMarker 204.

Specifically, a DeterminerPhraseMarker 310 is true only in case the set of x's that are R's are also in the set of x's that are P's as determined by the quantifier relationship Q. For instance, if Q is the universal quantifier, i.e., every or each, then the determiner relationship is |R−P=0, i.e., the set of x's that are R's less the set of x's that are P's is the null set.

Other quantifier relationships are defined according to Table III, assuming that α=|P−R|, β=|R−P|, γ=|R∩P|, δ=E−R∪P|, and E is the set of all entities, R is the set of all x's that are R's, and P is the set of all x's that are P's.

TABLE III
Quantifier Relationships

| Quantifier | Cardinal Formula |
|---|---|
| Every, each | β = 0 |
| Some, a(n), at least one, one or more | γ > 0 |
| No | γ = 0 |
| Exactly one | γ = 1 |
| At most one, one or less | γ ≦ 1 |

In addition to its quantificational uses, the DeterminerPhraseMarker 310 may be used to relate name constants and literal constants to predicates. In these cases, the relevant logical expression is given by P(c). Equivalently, this can be expressed as cεP. In other words, if the name or literal constant is one of the x's that are P's, then the DeterminerPhraseMarker 310 is true.

The DeterminerPhraseMarker 310 may also be used to refer to entities pronominally. When the pronominal quantifier is used, the entities referred to may be introduced by another DeterminerPhraseMarker 310 and is assumed to satisfy the universal β=0 quantifier relation (i.e., every).

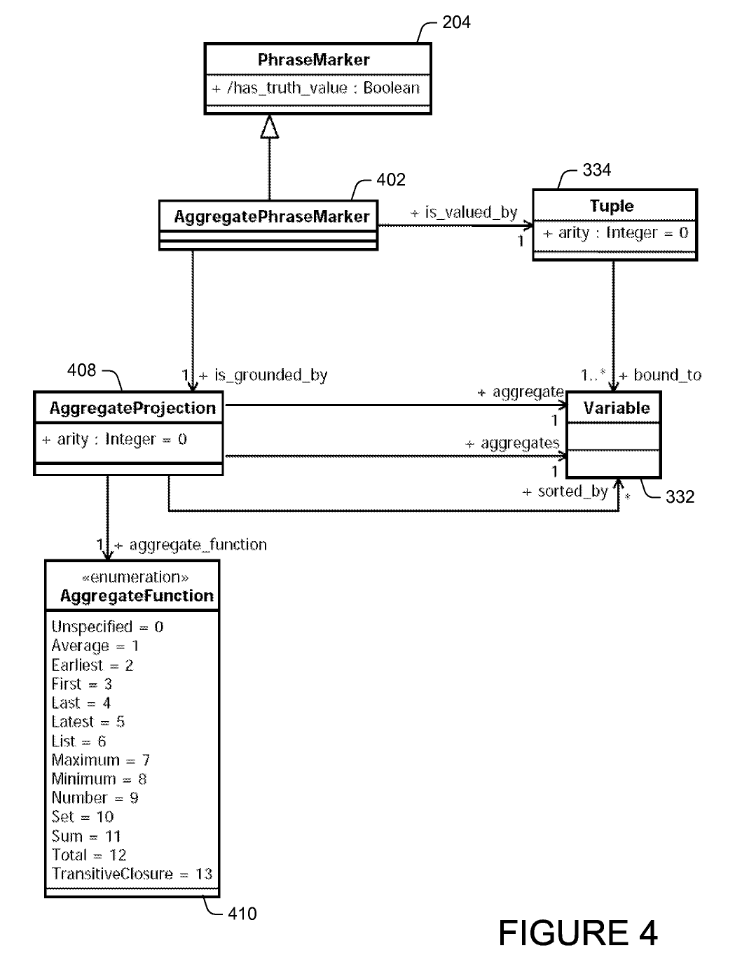

In some embodiments, an interrogative DeterminerPhraseMarker 310 may also be provided via an InterrogativeQuantifier 402 (FIG. 4). When the InterrogativeQuantifier 402 is used, the computation should capture and return those entities that satisfy the existential γ>0 quantifier relation (i.e., some) between the restriction and predicate.

In other embodiments, the DeterminerPhraseMarker 310 may further be used to associate a fact expression as an argument to a predicate. This use of the DeterminerPhraseMarker 310 is further described with respect to ComplementExpression 320. Accordingly, the DeterminerPhraseMarker 310 includes a restriction property and a predicate property. The restriction property is a projection (i.e., a collection or set of entities) of a specific type that are to be related to the predicate property by virtue of some quantifier relation that is also specified by the restriction property. The predicate property is a projection (i.e., a collection or set of entities) of a specific type that is to be related to the restriction property by virtue of some quantifier relation that is also specified by the restriction property.

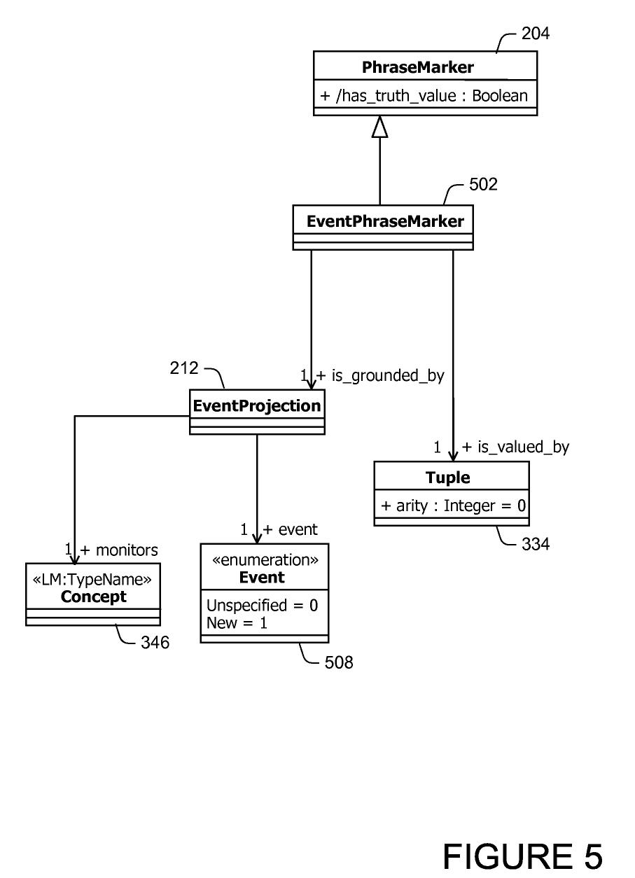

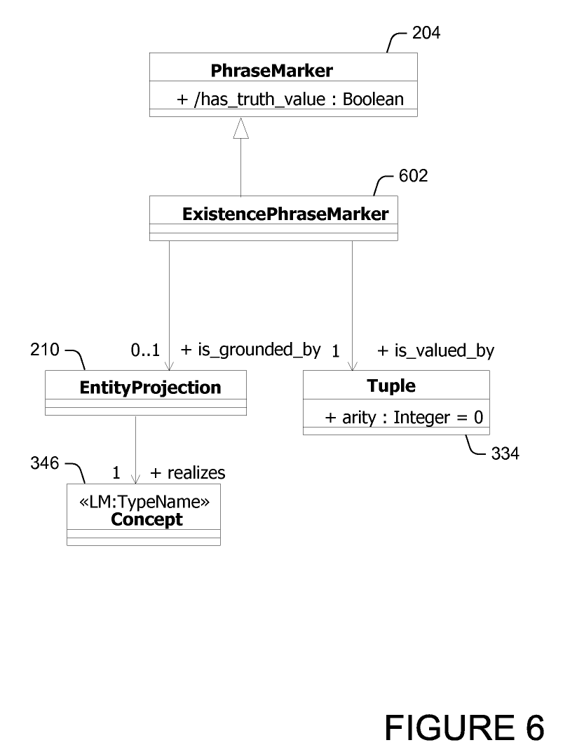

In addition to the phrase marker components described above, other phrase marker are derived from the PhraseMarker 204. These phrase marker components includes an AggregatePhraseMarker 402 that is described in FIG. 4, an EventPhraseMarker 502 that is described in FIG. 5, and an ExistencePhraseMarker 602 that is described in FIG. 6.

FIG. 4 illustrates an exemplary AggregatePhraseMarker 402 in accordance with various embodiments. The AggregatePhraseMarker 402 inherits from PhraseMarker 204. The AggregatePhraseMarker 402 enables a projection of aggregate values as determined by an AggregateProjection 214 (further described below). The AggregatePhraseMarker 402 includes a is_valued_by property and an is_grounded_by property. The is_valued_by property designates a Tuple 334 that identifies the one or more variables 406 to which the aggregation, that is, the projection's set of n-tuple entities applies. The is_grounded_by property designates the AggregateProjection 408 that projects the set of n-tuple entities.

As further shown in FIG. 4, the AggregateFunction 410 is used to specify the type of aggregation to be performed on the prescribed discourse referents. The AggregateFunction 410 include the values Average, Earliest, First, Last, Latest, List, Maximum, Minimum, Number, Set, Sum, Total, and TransitiveClosure.

The Average value indicates that an average will be computed according to the formula

$$\overline{x} = \frac{1}{N} {\sum }_{i} {x}_{i} .$$

This assumes that the discourse referent set consists of numeric entities. The discourse referent set may contain non-unique values, i.e., may be a multiset. The Earliest value indicates that an earliest timestamp from a collection of timestamps will be computed as ix: ∀y: x≠y→x [symbol] y. This assumes that the discourse referent set is a complete ordering and consists of timestamp entities. The discourse referent set may be a multiset.

The First value indicates that the entity corresponding to ordinal position “1” (one) within an ordered list will be computed. This assumes that the discourse referent set is an ordered list. The discourse referent set may be a multiset and may consist of entities of any type. The Last value indicates that the entity corresponding to ordinal position N within an ordered list will be computed, where N is the cardinality of the discourse referent set. This assumes that the discourse referent set is an ordered list. The discourse referent set may be a multiset and may consist of entities of any type.

The Latest value indicates that an the latest timestamp from a collection of timestamps will be computed as ix: ∀y: x≠y→x [symbol] y. This assumes that the discourse referent set is a complete ordering and consists of timestamp entities. The discourse referent set may be a multiset. The List value indicates that the elements of the discourse referent set will be enclosed by a set having the ordering property. This ordered set will then be made available within the discourse as a discourse referent making its elements opaque as they themselves pertain to discourse reference. This assumes that the discourse referent set is itself a complete ordering. The discourse referent set may be a multiset and may consist of entities of any type.

The Maximum value indicates that a maximum will be computed according to the formula ix: ∀y: x≠y→x>y. This assumes that the discourse referent set is a complete ordering and consists of numeric entities. The discourse referent set may be a multiset. The Minimum value indicates that a maximum will be computed according to the formula ix: ∀y: x≠y→x<y. This assumes that the discourse referent set is a complete ordering and consists of numeric entities. The discourse referent set may be a multiset.

The Number value indicates that the cardinality of the discourse reference set will be computed. The discourse referent set may contain entities of any type and may be a multiset. The Set value indicates that the elements of the discourse referent set will be enclosed by a set having the distinct property. This distinct set will then be made available within the discourse as a discourse referent making its elements opaque as they themselves pertain to discourse reference. No assumptions are made on the discourse referent. The discourse referent set may be a multiset and may consist of entities of any type.

The Sum value indicates that a sum will be computed according to the formula

$$x = {\sum }_{i} {x}_{i} .$$

This assumes that the discourse referent set consists of numeric entities. The discourse referent set may be a multiset. The Total value is synonymous with the Sum value (q.v.). The TransitiveClosure value indicates that a set consisting of those entities which are either directly related to a given entity by some relation or indirectly related to a given entity by some relation f under recursion. This is computed as the recursive function:

x(y,f)={x| [symbol] y,x [symbol] εf [symbol] (∃z:zεx(y,f) [symbol] y,z [symbol] εf)}.

This assumes that the discourse referent set is transitively closed. The discourse referent set may be a multiset and may consist of entities of any type.

FIG. 5 illustrates an exemplary EventPhraseMarker 502 in accordance with various embodiments. The EventPhraseMarker 502 inherits from PhraseMarker 204. The EventPhraseMarker 502 is a projection phrase marker. It is the primary means by which event information is exposed for computation. The EventPhraseMarker 502 includes an is_valued_by property and an is_grounded_by property. The is_valued_by property designates a Tuple 334 that identifies the variables to which the event applies. The is_grounded_by property designates an EventProjection 212 (FIG. 2) that projects a set of n-tuple entities (typically, a singleton characteristic function, i.e., a single entity) that correspond to an event that has occurred.

FIG. 6 illustrates an exemplary ExistencePhraseMarker 602 in accordance with various embodiments. The ExistencePhraseMarker 602 is a projection phrase marker and is the primary means by which the existence of an entity is projected. In this case, all (and only) those entities of the relevant entity type (as specified in the EntityProjection 210) are made available for computation. The ExistencePhraseMarker 602 includes an is_valued_by property, an is_grounded_by property, and an realizes property. The is_valued_by property designates a Tuple 334 (FIG. 3) that identifies the variables to which the existence check applies. The is_grounded_by property designates an EntityProjection 210 that projects a set of 1-tuple entities (typically, a singleton characteristic function, i.e., a single entity) that correspond to the existence of entities of some specified type. The realizes property indicates the type of the EntityProjection 210 and corresponds to the Concept 346.

### Expressions

Returning to FIG. 3, expressions are the means by which a sentence refers to entities. Each type of expression corresponds to a different aspect of language reference. Every expression computationally is responsible for projecting a set of 1-tuple entities. The set is then compared to some predicative operator by means of a quantifier relation Q.

As shown, the expressions may include a NonminalExpression 318, a ComplementExpression 320, a ConstantExpression 322, a QuantifierExpression 324, and a ValuationExpression 326.

The base class of the NominalExpression 318 is abstract. The NominalExpression 318 includes an introduces property. The introduces property designates a Variable 332 that is introduced by the nominal expression. The introduced variable corresponds to a new referent or set of referents that are related. For example, if the nominal expression corresponds to some person, the nominal expression introduces a new variable v that permits the nominal expression to be tied to a relational projection.

In another example, assume that there is a PropositionProjection 328 for the Relation 330 “person likes person.” This will be a binary relation consisting of a set of 2-tuples {person, person}. If a NominalExpression 318 introduces a variable 322 v and the PropositionProjection 328 is valued by the Tuple 334 {v, w}, then the NominalExpression 318 refers to the subject (i.e., first argument) position of the relation. However, if the Tuple 334 were {w, v}, then the NominalExpression 318 refers to the object (i.e., second argument) position of the relation.

The ComplementExpression 320 inherits from the NominalExpression 318. As stated earlier, the DeterminerPhraseMarker 310 may be used to associate a fact expression as an argument to a predicate. In effect, the sentence associated is “boxed” so as to make its truth conditions opaque to the sentence the fact expression is contained in. This means that the fact expression is merely pointed to, but not evaluated as to its truth conditions when contained within another sentence.

For example, in the sentence “Susan knows that John is an executive,” the actual truth of the pointed to expression John is an executive is not relevant to whether or not Susan knows it. This is commonly referred to as a meta-logical statement. In a meta-logical statement, the truth conditions of the statement embedded in a sentence need not be established and generally remain untested when determining the truth conditions of the embedding sentence. Nevertheless, the predicate that is used to characterize the boxed sentence requires that the embedded expression be “unboxed” so as to compute the veracity of the embedding sentence. For example, in the sentence “John likes Mary is true,” the boxed expression “John likes Mary” must be determined to be true as a consequence of the copula. In other words, the truth of the boxed expression is assigned to be true, so the copular expression must also be true.

However, in other instances, the boxed expression is used in query statements. In this case, the sentence is presented as part of a request or interrogation. The distinguishing artifact in such cases is the appearance of the wh-word whether. Whenever a sentence is prefixed by whether, the sentence is being offered for evaluation and an expected true or false response is to be computed. This corresponds to a typical yes-no question.

Accordingly, the ComplementExpression 320 includes a complementizer property and a boxes property. The complementizer property indicates that the boxed expression is declarative or interrogative. When the boxed expression is declarative, the boxed expression is considered to stand in the appropriate relation with the embedding sentence. However, if the boxed expression is interrogative, the expression is offered up for evaluation to obtain a yes or no answer. The boxes property designates the sentential object that is boxed, and is a sentential phrase marker.

As further shown in FIG. 3, a Complementizer enmeration 336 is included in the ComplementExpression 320. The Complementizer enumeration 336 is meant to encode the type of propositional boxing that is to be computed. The Complementizer 336 includes a value That and a value Whether. The That value indicates that the embedding expression merely refers to the boxed proposition governed by the That value. Any computation undertaken to evaluate the truth conditions of the boxed expression are done via extra-linguistic mechanisms. The primary example of this comes in the form of the authorization statement. An authorization brings about the creation of a communicative interface with a computational system wherein the boxed propositions are unboxed and evaluated either, in the case of interrogation, to obtain information from the computational system or, in the case where the That value would be used, to alter the state of affairs within the computational system so as to make the unboxed propositions true.

The Whether value indicates that the embedding expression merely refers to the boxed proposition governed by the Whether value. Any computation undertaken to evaluate the truth conditions of the boxed expression are done via extra-linguistic mechanism. When used in an authorization to request information, the Whether value indicates that the computational system should evaluate the truth of the boxed expression and return a yes-no answer upon invocation of the resulting communicative interface.

The ConstantExpression 322 inherits from the NominalExpression 312. The ConstantExpression 322 corresponds to a rigid name and refers to a Constant 338. The ConstantExpression 316 includes a refers_to property, which designates the Constant 338.

The QuantifierExpression 322 is a general instance of NominalExpression 318, and inherits from the NominalExpression 318. The QuantifierExpression 322 includes a quantifier property, a relative_clause property, and an is_grounded_by property.

The quantifier property designates the type of quantification that is to be computed. The relative_clause property designates a projection phrase marker (in this case, an OpenSentence 340) that serves to restrict the set of R's being considered relative to the set of P's defined by the predicate and the quantifier Q. For instance, given the sentence “the man that owns a dog walks the dog,” the relative clause “that own a dog” is used to constraint the set of “men” that are then evaluated against the predicate “walk the dog.” In this case, the Relation 330 “man owns dog” is evaluated and returns a set of {man, dog} 2-tuples, then the unique set of men are retrieved from this set. The resulting set of unique men (i.e., the dog owners) is then computed using universal quantification β=0 against the set of {man, dog} 2-tuples as computed by evaluating the Relation 330 “man walks dog.” The is_grounded_by property designates the EntityProjection 210 corresponding to the R's being evaluated against the entity projection P designated by the predicate property of the QuantifierExpression 324's parent DeterminerPhraseMarker 310.

Moreover, as described above with respect to the DeterminerPhraseMarker 310, a sentential phrase marker R∩C having a QuantifierExpression 324 as its restriction is true only in case the logical expression Qx [symbol] R(x): P(x) is true, where the quantifier property designates Q and the is_grounded_by property designates R. Thus, the relative_clause property acts as a way to constrain the set R by intersection as in R∩C, where C is the set of entities that project from the relative_clause property and R is the set of entities that project from the is_grounded_by property.

The ValuationExpression 326 corresponds to the use of a computation that determines the restriction set R. For instance, given the sentence “the sales total equals the sum of the line items totals”, the nominal expression “the sum of the line item totals” is an expression that projects a number but only by way of some computation. In principle, a ValuationExpression 326 uses a sentential projection to determine the set of R's to be computed against the set of P's as defined by the predicate and the universal quantifier β=0. The ValuationExpression 326 includes an is_ground_by property.

The is_grounded_by property designates the EntityProjection 210 corresponding to the R's being evaluated against the entity projection P designated by the predicate property of the ValuationExpression 326's parent DeterminerPhraseMarker 310. In the case of the ValuationExpression 320, the EntityProjection 210 is always an OpenSentence 340.

### Projections

Returning to FIG. 2, the LogicalFormObject 202 includes Projections 208. A projection is a collection of n-tuples that satisfy some n-ary relation. Put another way, those things are true of an n-ary relation are found in the relation's extension. Projections are manifestations of extensions. For example, given John likes Mary, Sam likes Georgina, Henry likes Juliet, and Mary likes John, then the projection or extension of the relation person likes person is the set:

{ [symbol] John, Mary [symbol] , [symbol] Sam, Georgina [symbol] [symbol] Henry, Juliet [symbol] , [symbol] Mary, John [symbol] }

In the above example, the pairing of Mary and John occurs twice. However, the order of each pairings is different for the two occurrences. Thus, the two occurrences mean different things as order is crucial to meaning. The two pairings of Mary and John may be contrasted with the single pair of Sam and Georgina. In the pairing of Sam and Georgina, while it is proper to say that Sam likes Georgina, it is not correct (or even true given the extension above) to say that Georgina likes Sam. In various embodiments, the Projections 208 has an abstract base class.

Further, additional projection components may be derived from the Projections 208. These projection components include an EntityProjection 210, an EventProjection 212, a PropositionalProjection 214, an AggregateProjection 216, and a LiteralProjection 344 (FIG. 3).

The EntityProjection 210 forms the basis for all characteristic extensions, i.e., extensions that consist of unary entities. The EntityProjection 210 inherits from Projections 208. Every entity (or object) comprising the EntityProjection 210 must be compatible with a given type. For instance, an EntityProjection 210 that projects the characteristic function badgers will contain badgers and only badgers, it will not contain any object or entity that is not a badger. The EntityProjection 210 includes a realizes property. The realizes property indicates the type of the EntityProjection 210 and corresponds to the Concept 346.

The EventProjection 212 is a projection that encodes the concept of introducing discourse referents by virtue of the occurrence of some kind of computational event. The EventProjection 212 inherits from Projections 208. The EventProjection 212 supports an event that is the creation of a new entity. The EventProjection 212 serves to provide a grounding for a nominal expression which relies on an entity coming into existence to be introduced into the discourse. For instance, given the sentence “upon a new account, it is declared that the account balance of the account is 0,” the “upon” clause introduces an EventProjection 212 consisting of accounts that come into existence at the time the sentence is computed by the discourse. The EventProjection 212 includes a monitors property and an event property. As further shown in FIG. 5, the monitors property specifies the Concept 346 over which events are being considered. The event property indicates the type of monitoring that is to be computed. Moreover, an Event enumeration 506 is included in the EventProjection 212. The Event enumeration 506 is meant to encode the type of monitoring that an EventProjection 212 entails. The Event enumeration 506 includes a New value. The New value indicates that a computation projects entities that are new to the computational system.

The PropositionalProjection 214 is the means by which relational knowledge is conveyed. For example, given a relation “man loves woman”, the relation's PropositionalProjection 214 is the set of [symbol] man, woman [symbol] 2-tuples for which the relation is true. The PropositionalProjection 214 includes a realizes property and an arity property. The realizes property indicates the Logical Model Relation projected by the PropositionalProjection 214. The arity property indicates the number of entity arguments for the relation specified by the Relation 330. For example, the arity property determines the number of n for the n-tuples that are projected, and in particular, the number of columns in a database table that corresponds to the Logical Model Relation.

The AggregateProjection 216 is a projection that encodes the details of an aggregation operation over discourse referents. For example, given the sentence, “given that a sale has a sale item, the total of the sale is the sum of the quantity of the sale item×the price of the sale item,” the sum aggregation of the quantity×price of each sale item may be encoded by the AggregateProjection 216. The AggregateProjection 216 includes an aggregate property, an aggregates property, a sorted_by property, an aggregate_function property, and an arity property.

The aggregate property references a variable that corresponds to the “return” value of the aggregation operation and must correspond to one of the variables bound by the Tuple 334 (FIG. 3) that values the AggregateProjection 216's parent AggregatePhraseMarker 402. The aggregates property references a variable that corresponds to the discourse referent set of values to aggregate. The sorted_by property is a multivalued reference to variables in the discourse which partition the discourse referent set indicated by the aggregates property. Moreover, the aggregate_function property indicates the aggregation operation to be executed. The arity property indicates the number of sorting arguments plus one and must correspond to the arity property of the Tuple 334 (FIG. 3) that values the AggregateProjection 216's parent AggregatePhraseMarker 402.

The LiteralProjection 344 provides the extension of a literal constant such as a string or integer. The LiteralProjection 344 inherits from EntityProjection 210. The LiteralProjection 344 is used as the projection of a quantifier expression restriction. For instance, in the sentence “the account balance of a new account is 0”, the literal argument “0” (zero) is a whole number argument and restricts the object noun phrase to be that number. The LiteralProjection 344 includes a value property. The value property is the value that is projected. This projection is a singleton having a type compatible with the realizes property.

The OpenSentence 340 is the means by which propositional content is projected upwards to a NominalExpression 318 that is to be evaluated against. Specifically, since every quantificational operation requires both a restriction R and a predicate P, the OpenSentence 340 corresponds to the predicate P. As an example, given the sentence, “every man loves some woman”, the quantificational expression for every man requires a predicate P which in this case is the predicate loves-some-woman(x) and consists of the set of all x that love some woman (that is, the set of all men x).

In addition to its usage in predicate projection, the OpenSentence 340 is also used to project the relative clause set C. Similar in nature to the projection of a predicate P, the projection of a relative clause C is simply the typed set of entities that satisfy some characteristic function. As an example, given the nominal expression, “each man that loves some woman,” the restriction set R of all men is constrained by intersection with the set of all men x that love some woman. The OpenSentence 340 includes a projects_from property and a projects_onto property. The projects_from property is a PhraseMarker 204 with the property that at least one of its variables is unbound. The unbound variable that obtains the extension of the predicate projection P is determined by the PropositionalProjection 214 grounded by an applicable PropositionPhraseMarker 304 governed by the projects_from property.

The projects_onto property indicates which variable obtains the predicate projection P as determined by the PropositionalProjection 214 grounded by an applicable PropositionPhraseMarker 304 governed by the projects_from property. The projects_onto property must correspond to one of the variables that the relevant PropositionPhraseMarker 304 binds.

### Quantifiers

Sentences that involve quantification are sentences that describe “how many” things satisfy “some” property. Specifically, the formatives each, some, no, at least two but less than seven, etc., are quantifiers. Each quantifier conveys a function between the set of things being quantified and the set of things satisfying the property being quantified over. For example, in the sentence “no man agrees”, the things being quantified are “men” and the property being quantified over is the set of things that are agreeable.

Accordingly, the LogicalFormObject 202 includes ComplexQuantifier 348 (FIG. 3). The ComplexQuantifier 348 provides a foundational class for specifying the function that applies to a predicate-restriction pair. The ComplexQuantifier 348 includes the modifier property and the base_quantifier property. The modifier property indicates discourse specific cues for driving the introduction of discourse referents. Two values may be permitted: “new” and “given”.

For the modifier new, the intended semantic interpretation is that the discourse referent (or referents) is (are) new to the computational system. Specifically, new discourse referents must not have been a part of the knowledge base prior to the start of the discourse in which the new modifier is used.

For the modifier given, the intended semantic interpretation is that the discourse referent (or referents) has (have) been externally introduced to the discourse in which the given modifier is used. In general, externally introduced discourse referents must be communicated to the computational system by way of a programmatic interface. Further, the base_quantifier property indicates the type of quantification that is to be applied to the predicate-restriction pair.

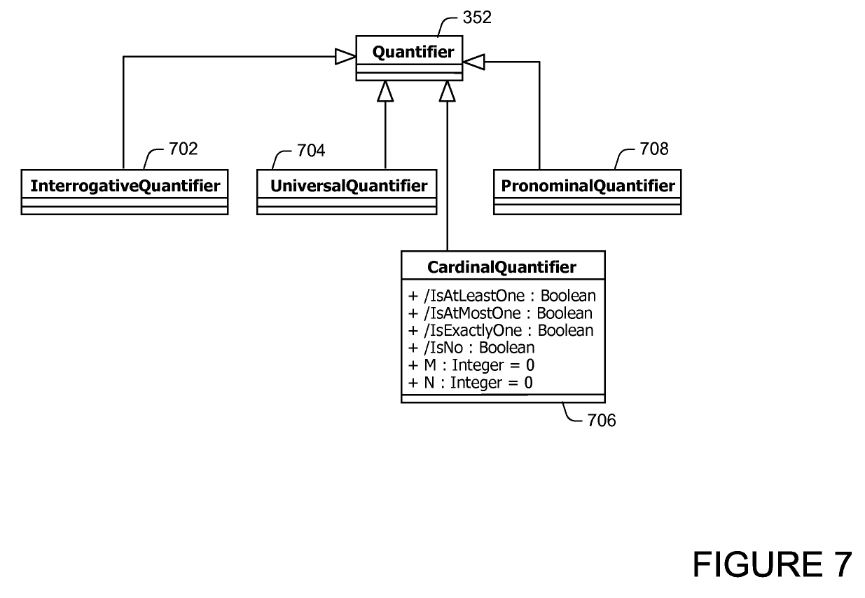

Accordingly, the ComplexQuantifier 348 includes a Modifier enumeration 350. The Modifier enumeration 350 permits the alteration of the defined semantics for the introduction of discourse referents into a discourse. The Modifier enumeration 350 includes a Given value and a New Value. The Given value is meant to enforce the constraint that a given discourse referent has been introduced to the discourse prior to the computation of the discourse in question. The New value is meant to enforce the constraint that a given discourse referent be new to the computational system at the time of the computation of the discourse in question. The LogicalFormObject 202 also includes Quantifier 352. The Quantifier 352 base class is abstract. Further, as shown in FIG. 7, additional quantifier components are derived from the Quantifier 352.

FIG. 7 is a block diagram illustrating the various components of a Quantifier 352, in accordance with various embodiments. As shown, the components include an InterrogativeQuantifier 702, an UniversalQuantifier 704, a CardinalQuantifier 706, and a PronominalQuantifier 708.

The InterrogativeQuantifier 702 is the means by which questions may be asked of a computational system. The InterrogativeQuantifier 702 inherits from the Quantifier 352. The InterrogativeQuantifier has semantics similar to the existential quantifier some, but has the property of being a complete cover of the predicate and restriction projections. In essence, the computation of an interrogative obtains the set R∩P. When nested, the computation of an interrogative obtains a structured set of n-tuples based on the sets Rᵢ∩Pᵢ and a composition function x⊕y that ensures members of x are associated with members of y by virtue of some relation P that yields the predicate projections Pₓ and P_{y} such that x=Rₓ∩Pₓ and y=R_{y}∩P_{y}.

The UniversalQuantifier 704 is the means by which universality is expressed. The UniversalQuantifier 704 inherits from the Quantifier 326. Universal quantification satisfies the cardinal function β0.

The CardinalQuantifier 706 is the means by which proportional functions are introduced. The CardinalQuantifier 706 also inherits from the Quantifier 352. The term Cardinal stems from the fact that all cardinal quantifiers can be expressed in terms of a comparison to the cardinal numbers 0, 1, 2, . . . . In computational terms, the intersection of the predicate and restriction sets, P and R, are compared by way of one or more inequalities to cardinal numbers. For instance, the cardinal quantifier some is taken to mean |R∩P|>0. Normally, the Greek letter γ is assigned to the expression |R∩P|, so that cardinal quantifier functions take the form γ?n, where ? is an inequality (“=”, “≠”, “ ”, “ ” etc.), and n is a cardinal number.

The CardinalQuantifier 706 includes a is_at_least_one property, an is_at_most_one property, an is_exactly_one property, an is_no property, a M property, and a N property. The is_at_least_one property is a Boolean property that indicates whether or not a CardinalQuantifier 706 represents the function γ≧1. The is_at_most_one property is a Boolean property that indicates whether or not the CardinalQuantifier 706 represents the function γ≦1. The is_exactly_one property is a Boolean property that indicates whether or not the CardinalQuantifier 706 represents the function γ=1. The is_no property is a Boolean property that indicates whether or not the CardinalQuantifier 706 represents the function γ=0.

The M property is the upper bound of the cardinal relationship. In the most general terms, a cardinal quantifier function takes the form N?γ?M, though typically, either M and N are equal or N is zero, thus leading to the more familiar form γ?M. As an example, the quantifier “more than 2 and less than 7” yields the cardinal function 2<γ<7, where M=7 and N=2. Likewise, the N property is the lower bound of the cardinal relationship. In the most general terms, a cardinal quantifier function takes the form N?γ?M, though typically, either M and N are equal or N is zero, thus leading to the more familiar form γ?M. As an example, the quantifier “more than 2 and less than 7” yields the cardinal function 2<γ<7, where M=7 and N=2.

The PronominalQuantifier 708 is the means by which pronominal reference is achieved. The occurrence of the PronominalQuantifier 708 assumes the prior introduction of a discourse referent corresponding to the Variable 332 introduced by the QuantifierExpression 324 governing the PronominalQuantifier 708. The cardinality of the expression is that of universal quantifications β=0.

### Variable

Variable bindings are the means by which the relationships between discourse referents introduced by nominal expressions and their respective propositional arguments are maintained. Specifically, if a nominal expression introduces a variable v, then there must be a projection phrase marker that is valued by an n-tuple of variables having v as a member. For example, given the sentence “every man walks”, the nominal expression “every man” must introduce a variable v and the propositional phrase marker walks(v) must be valued by a 1-tuple that binds to v. In predicate calculus terms this is expressed as ∀v [symbol] man(v): walks(v) and reads as “for all v such that v is a man, v walks”.

Returning to FIG. 3, the LogicalFormObject 202 includes a variable 332. The Variable 332 is a meta-logical object that permits the passing of values between nominal expressions and relations. In a set-theoretic model framework, the process of passing values is abstracted into ordered projections, but the principle is the same, in so far as the association between an entity projection and a particular argument of a relation is concerned. As an example, given the relation “person likes person” and the sentence “every person likes some person”, two variables are introduced by the two nominal expressions “every person” and “some person”. If the logical form for the sentence is given as ∀v₁ [symbol] person (v₁): ∃v₂ [symbol] person (v₂): like (v₁, v₂), then looking only at the nominal expression of the subject argument “every person”, the connection between the first argument of the like relation. This translates into a projection of persons by the nominal expression “every person” and a projection of persons corresponding to the first argument of the like relation. These two projections are then compared using the appropriate cardinal quantifier function β=0.

The variable 332 includes a ranges_over property and an index property. The ranges_over property indicates the Concept 346 that the variable 332 stands for. The index property is used to permit surfacing logical structures to be presented in a human readable format. The index corresponds to the subscript values i of vᵢ.

### Tuple

The Tuple 334 is the means by which variables introduced into the discourse by nominal expressions are associated with a PropositionPhraseMarker 304 (and also the AggregatePhraseMarker 402). Crucially, the Tuple 334 is an ordered set of distinct variables. This ensures that the mapping between quantified expressions and their respective function arguments form a one-to-one mapping and that the order in which the variables are introduced to the discourse is independent of the order in which the arguments appear in the relation.

The Tuple 334 includes a bound_to property and a arity property. The bound_to property is an ordered collection of variables. Each variable in the collection must be a variable that has been introduced by a NominalExpression 318. The arity property indicates the number of variable arguments bound to by the Tuple 334.

### Exemplary Processes

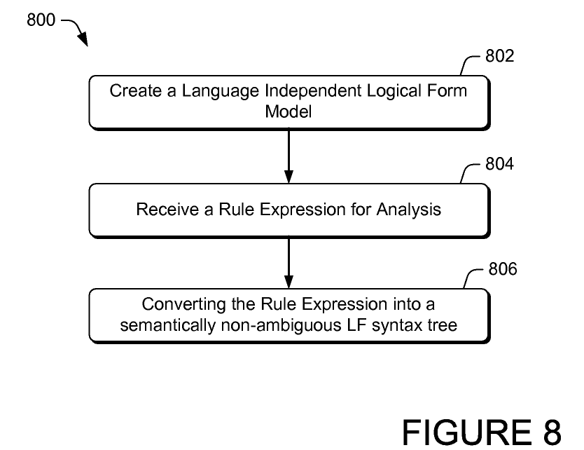

FIGS. 8-18 illustrate exemplary processes that facilitate the conversion of a Computational Independent Model (CIM) rule expression into a semantically non-ambiguous syntax tree. The exemplary processes in FIGS. 8-10 are illustrated as a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are presently described is not intended to be construed as a limitation, and any number of the described blocks can be combined in any order and/or in parallel to implement the process. For discussion purposes, the processes are described with reference to the exemplary logical form (LF) transformer 102 of FIG. 1, although they may be implemented in other system architectures. In various embodiments, the processing, projection, and assembly described in FIGS. 8-18 may be implemented using the Logical Form (LF) model 118 of the logical form (LF) transformer 102.

FIG. 8 is a flow diagram illustrating an exemplary process 800 for converting a rule expression into a semantically non-ambiguous syntax tree based on a Logical Form (LF) model, in accordance with various embodiments. At block 802, a language independent logical form model, such as the LF model 116 described with respect to FIGS. 1-7, may be created for an LF transformer 102 (FIG. 1). As described above, the LF Model 116 may serve as the basis for the generation of a semantically non-ambiguous LF syntax tree from CIM rule expressions. At block 804, a CIM rule expression, such as the CIM rule expression 104 (FIG. 1), may be received into the LF transformer 102 for analysis. At block 806, the LF transformer 102 may translate the rule expression into a semantically non-ambiguous LF syntax tree. Specifically, the CIM rule expression 104 may be analyzed for rules and expressions. In some embodiments, conditional clauses of the CIM rule expression 104 may be adjoined to resolve the anaphoric references within the sentential structure of the syntax of the rule expression during block 806.

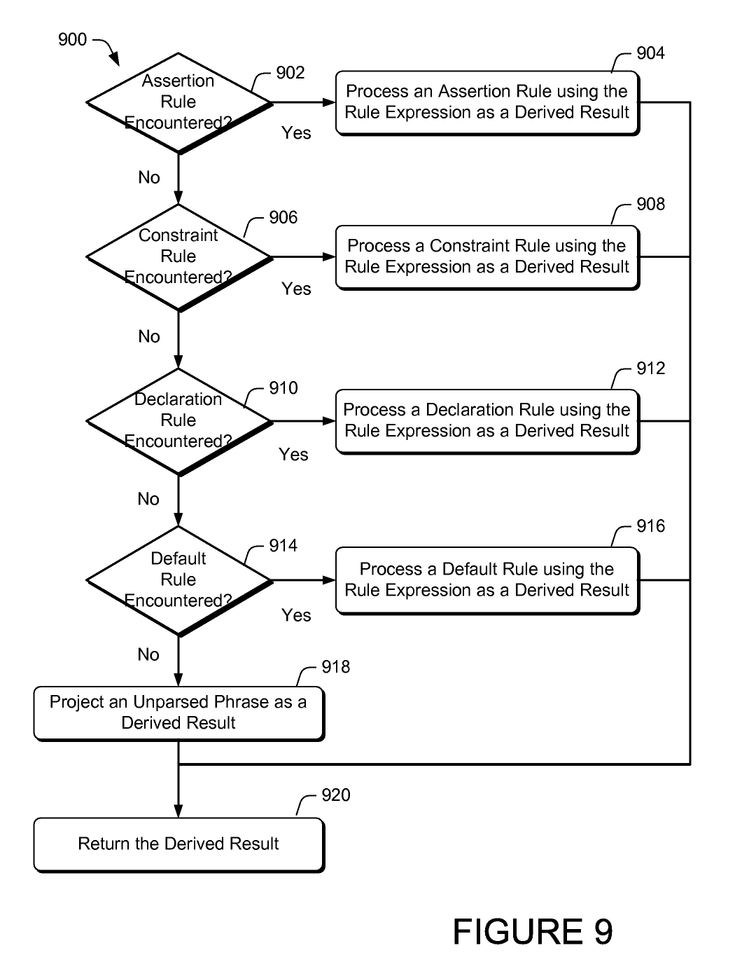

FIG. 9 is a flow diagram illustrating an exemplary process for transforming a Computational Independent Model (CIM) rule expression in accordance with various embodiments. Exemplary process 900 may further illustrate block 806 of the exemplary process 800. The exemplary process 900 may be implemented in combination and/or in parallel with other processes, such as processes 1000-1800. Indeed, according to various embodiments, the LF conversion algorithm 118 may implement the analysis of a rule expression by recursive descent through the sentential structure of the rule expression.

At decision block 902, the logical form (LF) conversion algorithm 118 of the LF transformer 102 may determine whether an assertion rule is encountered in a CIM rule expression. If the LF conversion algorithm 118 determines that an assertion rule is encountered (“yes” at decision block 902), the process 900 may proceed at block 904. At block 904, the LF conversion algorithm 118 may process the assertion rule from the input of the CIM rule expression to obtain a derived result. However, if the LF conversion algorithm 118 determines that an assertion rule is not encountered (“no” at decision block 902), the process 900 may proceed to block 906.

At decision block 906, the LF conversion algorithm 118 may determine whether a constraint rule is encountered in the CIM rule expression. If the LF conversion algorithm 118 determines that a constraint rule is encountered (“yes” at decision block 906), the process 900 may proceed to block 908. At block 908, the LF conversion algorithm 118 may process the constraint rule from the input of the CIM Rule expression to obtain a derived result. However, if the LF conversion algorithm 118 determines that a constraint rule is not encountered (“no” at decision block 906), the process 900 may proceed to block 910.

At decision block 910, the LF conversion algorithm 118 may determine whether a declaration rule is encountered in the CIM rule expression. If the LF conversion algorithm 118 determines that a declaration rule is encountered (“yes” at decision block 910), the process 900 may proceed to block 912. At block 912, the LF conversion algorithm 118 may process the declaration rule from the input of the CIM rule expression to obtain a derived result. However, if the LF conversion algorithm 118 determines that a declaration rule is not encountered (“no” at decision block 912), the process 900 may proceed to block 914.

At decision block 914, the LF conversion algorithm 118 may determine whether a default rule is encountered in the CIM rule expression. If the LF conversion algorithm 118 determines that a default rule is encountered (“yes” at decision block 914), the process 900 may proceed to block 916. At block 916, the LF conversion algorithm 118 may process the default rule from the input of the CIM rule expression to obtain a derived result, then proceed to block 920.

However, if the LF conversion algorithm 118 determines that a default rule is not encountered (“no” at decision block 914), the process 900 may proceed to proceed to block 918. At block 918, the LF conversion algorithm 118 may project an unparsed phrase as a derived result. At block 920, the LF conversion algorithm 118 may return the derived result as part of a semantically non-ambiguous LF syntax tree.

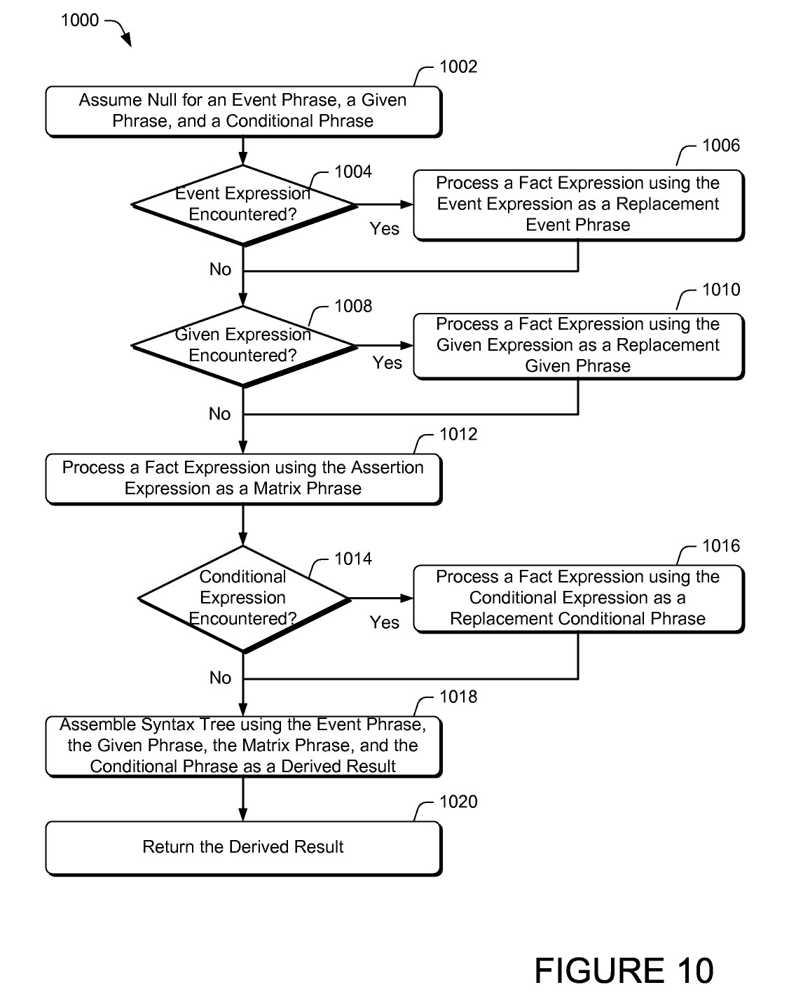

FIG. 10 is a flow diagram illustrating an exemplary process 1000 for processing an assertion in a Computational Independent Model (CIM) rule expression in accordance with various embodiments. Exemplary process 1000 may further illustrate block 904 of the exemplary process 900.

At block 1002, the LF conversion algorithm 118 of the LF transformer 102 may preset the values of an event phrase, a given phrase, and a conditional phrase that may correspond to a possible event expression, a possible given expression, and a possible conditional expression, respectively, in a CIM rule expression to null. In other words, the LF conversion algorithm 118 is aware that such expressions are possibly present in the CIM rule expression when it is processing the CIM rule expression for an assertion. The preset of the null values for the phrases ensures that if the LF conversion algorithm 118 does not find a one or more of the expressions, the LF conversion algorithm 118 may use the one or more corresponding null values during an assembly of a semantically non-ambiguous LF syntax tree.

At decision block 1004, the LF conversion algorithm 118 may determine whether an event expression is encountered in the CIM rule expression. If the LF conversion algorithm 118 determines that an event expression is encountered (“yes” at decision block 1004), the process 1000 may proceed to block 1006. At block 1006, the LF conversion algorithm 118 may process a fact expression using the encountered event expression replacing the null event phrase from block 1002 as an event phrase. Following processing at block 1006, the process 1000 may proceed to block 1008. However, if the LF conversion algorithm 118 determines that an event expression is not encountered (“no” at decision block 1004), the process 1000 may proceed directly to decision block 1008.

At decision block 1008, the LF conversion algorithm 118 may determine whether a given expression is encountered in the CIM rule expression. If the LF conversion algorithm 118 determines that a given expression is encountered (“yes” at decision block 1008), the process 1000 may proceed to block 1010. At block 1010, the LF conversion algorithm 118 may process the fact expression using the encountered given expression replacing the null given phrase from block 1002 as a given phrase. Following process at block 1010, the process 1000 may proceed to block 1012. However, if the LF conversion algorithm 118 determines that a given expression is not encountered, (“no” at decision block 1008), the process 1000 may proceed directly to block 1012.

At block 1012, the LF conversion algorithm 118 may process the fact expression using the assertion expression as a matrix phrase. As used herein, matrix phrase may refer to the core proposition of a sentence, as distinguished from modifying clauses such as conditional, event, and/or given clauses.

At decision block 1014, the LF conversion algorithm 118 may determine whether a conditional expression is encountered in the CIM rule expression. If the LF conversion algorithm 118 determines that a conditional expression is encountered (“yes” at decision block 1014), the process 1000 may proceed to block 1016.

At block 1016, the LF conversion algorithm 118 may process the fact expression using the encountered conditional expression replacing the null conditional phrase from block 1002 as a conditional phrase. Following processing at block 1016, the process 1000 may proceed to block 1018. However, if the LF conversion algorithm 118 determines that a conditional expression is not encountered (“no” at decision block 1016), the process 1000 may proceed to directly to block 1018.

At block 1018, the LF conversion algorithm 118 may assemble at least a portion of the semantically non-ambiguous LF syntax tree using any encountered event phrase, given phrase, and matrix phrase, and conditional phrase. The assembly portion may constitute the derived result. At block 1012, the LF conversion algorithm 118 may return the derived result as part of a semantically non-ambiguous LF syntax tree.

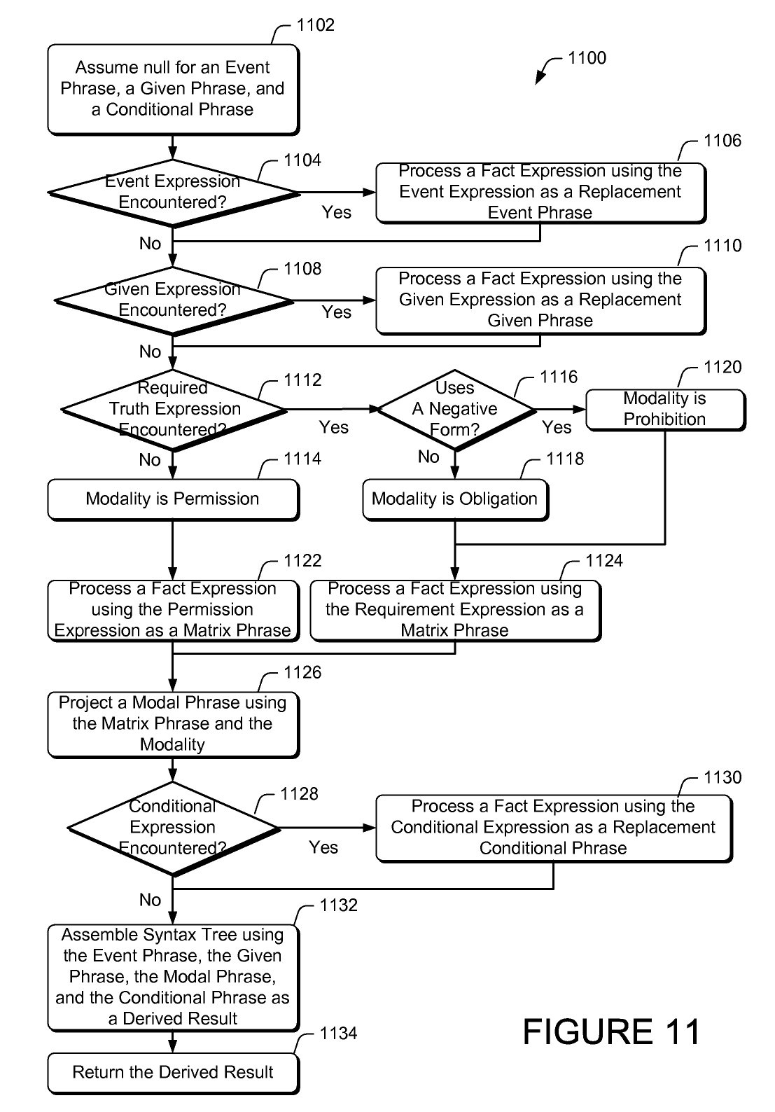

FIG. 11 is a flow diagram illustrating an exemplary process 1100 for processing a constraint in a Computational Independent Model (CIM) rule expression in accordance with various embodiments. Exemplary process 1100 may further illustrate block 908 of the exemplary process 900.

At block 1102, the LF conversion algorithm 118 of the LF transformer 102 may preset the values of an event phrase, a given phrase, and a conditional phrase that may correspond to a possible event expression, a possible given expression, and a possible conditional expression, respectively, in a CIM rule expression to null. In other words, the LF conversion algorithm 118 is aware that such expressions are possibly present in the CIM rule expression when it is processing the CIM rule expression for an assertion. The preset of the null values for the expressions ensures that if the LF conversion algorithm 118 does not find a one or more of the expressions, the LF conversion algorithm 118 may use the one or more corresponding null values during an assembly of a semantically non-ambiguous tree.

At decision block 1104, the LF conversion algorithm 118 may determine whether an event expression is encountered in the CIM rule expression. If the LF conversion algorithm 118 determines that an event expression is encountered (“yes” at decision block 1104), the process 1100 may proceed to block 1106. At block 1106, the LF conversion algorithm 118 may process a fact expression using the encountered event expression replacing the null event phrase from block 1102 as an event phrase. Following processing at block 1106, the process 1100 may proceed to block 1108. However, if the LF conversion algorithm 118 determines that an event expression is not encountered (“no” at decision block 1104), the process 1100 may proceed directly to decision block 1108.

At decision block 1108, the LF conversion algorithm 118 may determine whether a given expression is encountered in the CIM rule expression. If the LF conversion algorithm 118 determines that a given expression is encountered (“yes” at decision block 1108), the process 1100 may proceed to block 1110. At block 1110, the LF conversion algorithm 118 may process the fact expression using the encountered given expression replacing the null given phrase from block 1102 as a given phrase. Following processing at block 1110, the process 1100 may proceed to block 1112. However, if the LF conversion algorithm 118 determines that a given expression is not encountered, (“no” at decision block 1108), the process 1100 may proceed directly to block 1112.

At decision block 1112, the LF conversion algorithm 118 may determine whether a required truth expression is encountered in the CIM rule expression. If the LF conversion algorithm 118 determines that a required truth expression is not encountered (“no” at decision block 1112), the process 1100 may proceed to block 1114. At block 1114, LF conversion algorithm 118 may determine that the modality of the expression is “permission.” Following the determination at block 1114, the process 1100 may proceed to block 1122.

However, if the LF conversion algorithm 118 determines that a required truth expression is encountered (“yes” at decision block 1112), the process 1100 may proceed to block 1116.

At block 1116, the LF conversion algorithm 118 may determine whether the truth expression uses a negative form. If the LF conversion algorithm 118 determines that the truth expression does not use a negative form (“no” at decision block 1116), the process 1100 may proceed to block 1118. At block 1118, the LF conversion algorithm 118 may determine that the modality of the expression is “obligation”. Following determination at block 1118, the process 1100 may proceed to block 1124.

However, if the LF conversion algorithm 118 determines that the truth expression uses a negative form (“yes” at decision block 1116), the process 1100 may proceed to block 1120. At block 1120, the LF conversion algorithm 118 may determined that the modality of the expression is “prohibition.” Following determination at block 1124, the process 1100 may proceed to block 1124.

Returning to block 1122, the LF conversion algorithm 118 may process the fact expression using the determined permission expression as a matrix phrase. Following processing at block 1122, the process 1100 may proceed to block 1126. Turning to block 1124, the LF conversion algorithm 118 may process the fact expression using the determined requirement expression (as determined in one of the block 1118 or block 1120) as a matrix phrase. Following processing at block 1124, the process 1100 may proceed to block 1126.

At block 1126, the LF conversion algorithm 118 may project a modal phrase by using the matrix phrase and the modality.

At decision block 1128, the LF conversion algorithm 118 may determine whether a conditional expression is encountered in the CIM rule expression. If the LF conversion algorithm 118 determines that a conditional expression is encountered (“yes” at decision block 1128), the process 1100 may proceed to block 1130. At block 1130, the LF conversion algorithm 118 may process the fact expression using the conditional expression replacing the null conditional phrase from block 1102 as a conditional phrase. Following processing at block 1130, the process 1100 may proceed to block 1132.

However, if the LF conversion algorithm 118 determines that a conditional expression is not encountered (“no” at decision block 1128), the process 1100 may proceed directly to block 1132.

At block 1132, the LF conversion algorithm 118 may assemble at least a portion of the semantically non-ambiguous LF syntax tree using any encountered event phrase, given phrase, modal phrase, and conditional phrase. The assembly portion may constitute the derived result. At block 1134, the LF conversion algorithm 118 may return the derived result as part of a semantically non-ambiguous LF syntax tree.

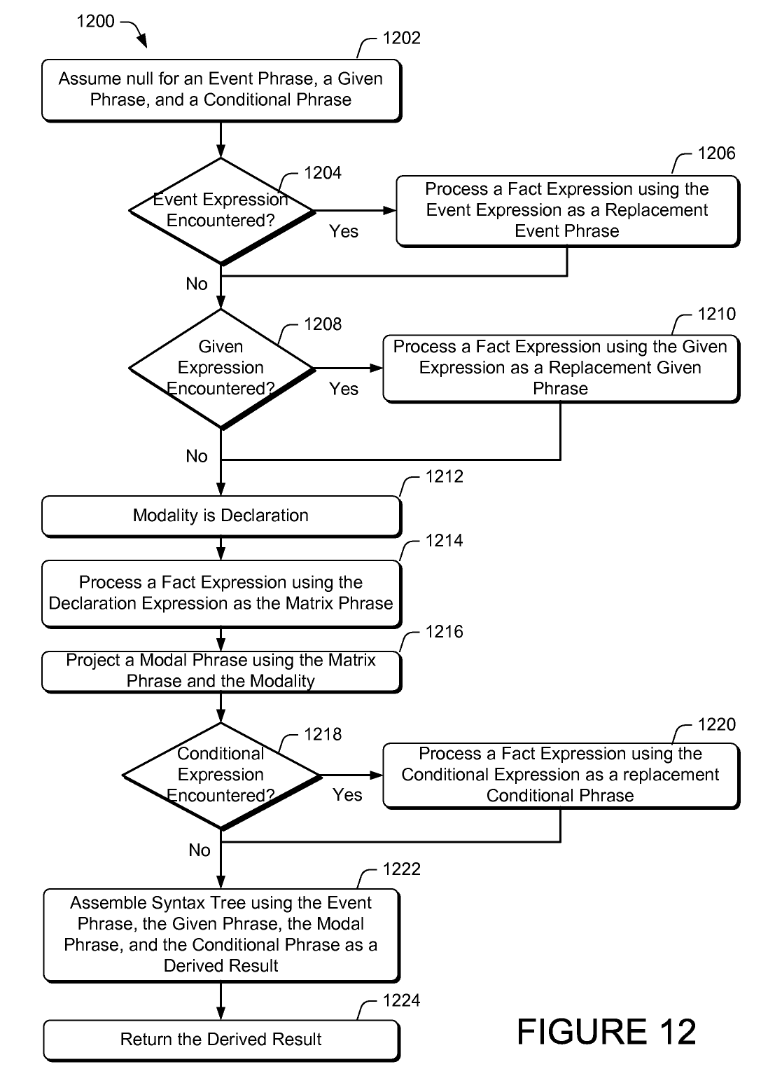

FIG. 12 is a flow diagram illustrating an exemplary process for processing a declaration in a Computational Independent Model (CIM) rule expression in accordance with various embodiments. Exemplary process 1200 may further illustrate block 912 of the exemplary process 900.

At block 1202, the LF conversion algorithm 118 of the LF transformer 102 may preset the values of an event phrase, a given phrase, and a conditional phrase that may correspond to a possible event expression, a possible given expression, and a possible conditional expression, respectively, in a CIM rule expression to null. In other words, the LF conversion algorithm 118 is aware that such expressions are possibly present in the CIM rule expression when it is processing the CIM rule expression for an assertion. The preset of the null values for the expressions ensures that if the LF conversion algorithm 118 does not find a one or more of the expressions, the LF conversion algorithm 118 may use the one or more corresponding null values during an assembly of a semantically non-ambiguous tree.

At decision block 1204, the LF conversion algorithm 118 may determine whether an event expression is encountered in the CIM rule expression. If the LF conversion algorithm 118 determines that an event expression is encountered (“yes” at decision block 1204), the process 1200 may proceed to block 1206. At block 1206, the LF conversion algorithm 118 may process a fact expression using the encountered event expression replacing the null event phrase from block 1202 as an event phrase. Following processing at block 1206, the process 1200 may proceed to decision block 1208. However, if the LF conversion algorithm 118 determines that an event expression is not encountered (“no” at decision block 1204), the process 1200 may proceed directly to decision block 1208.

At decision block 1208, the LF conversion algorithm 118 may determine whether a given expression is encountered in the CIM rule expression. If the LF conversion algorithm 118 determines that a given expression is encountered (“yes” at decision block 1208), the process 1200 may proceed to block 1210. At block 1210, the LF conversion algorithm 118 may process the fact expression using the encountered given expression replacing the null given phrase from block 1202 as a given phrase. Following processing at block 1210, the process 1200 may proceed to block 1212. However, if the LF conversion algorithm 118 determines that a given expression is not encountered, (“no” at decision block 1208), the process 1200 may proceed directly to block 1212.

At block 1212, the LF conversion algorithm 118 may determine that the modality of the expression is “declaration.” At block 1214, the LF conversion algorithm 118 may process the fact expression using the declaration expression as a matrix phrase.

At decision block 1216, the LF conversion algorithm 118 may project a modal phrase using the matrix phrase and the modality.

At decision block 1218, the LF conversion algorithm 118 may determine whether a conditional expression is encountered in the CIM rule expression. If the LF conversion algorithm 118 determines that a conditional expression is encountered (“yes” at decision block 1218), the process 1200 may proceed to block 1220. At block 1220, the LF conversion algorithm 118 may process the fact expression using the encountered conditional expression replacing the null conditional phrase from block 1202 as a conditional phrase. Following processing at block 1220, the process 1200 may proceed to block 1222. However, if the LF conversion algorithm 118 determines that an event expression is not encountered (“no” at decision block 1218), the process 1200 may proceed directly to block 1222.

At block 1222, the LF conversion algorithm 118 may assemble at least a portion of the semantically non-ambiguous LF syntax tree using any encountered event phrase, given phrase, modal phrase, and conditional phrase. The assembly portion may constitute the derived result. At block 1224, the LF conversion algorithm 118 may return the derived result as part of a semantically non-ambiguous LF syntax tree.

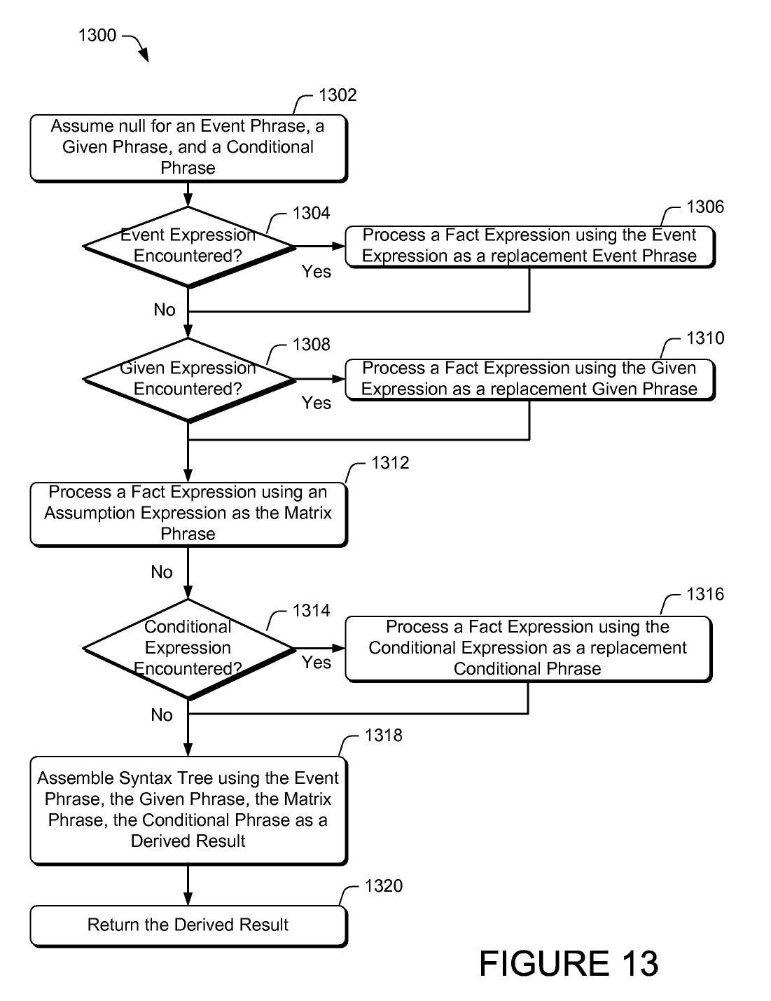

FIG. 13 is a flow diagram illustrating an exemplary process for processing a default rule in a Computational Independent Model (CIM) rule expression in accordance with various embodiments. Exemplary process 1300 may further illustrate block 916 of the exemplary process 900.

At block 1302, the LF conversion algorithm 118 of the LF transformer 102 may preset the values of an event phrase, a given phrase, and a conditional phrase that may correspond to a possible event expression, a possible given expression, and a possible conditional expression, respectively, in a CIM rule expression to null. In other words, the LF conversion algorithm 118 is aware that such expressions are possibly present in the CIM rule expression when it is processing the CIM rule expression for an assertion. The preset of the null values for the expressions ensures that if the LF conversion algorithm 118 does not find a one or more of the expressions, the LF conversion algorithm 118 may use the one or more corresponding null values during an assembly of a semantically non-ambiguous tree.

At decision block 1304, the LF conversion algorithm 118 may determine whether an event expression is encountered in the CIM rule expression. If the LF conversion algorithm 118 determines that an event expression is encountered (“yes” at decision block 1304), the process 1300 may proceed to block 1306. At block 1306, the LF conversion algorithm 118 may process a fact expression using the encountered event expression replacing the null event phrase from block 1302 as an event phrase. Following processing at block 1306, the process 1300 may proceed to decision block 1308. However, if the LF conversion algorithm 118 determines that an event expression is not encountered (“no” at decision block 1304), the process 1300 may proceed directly to decision block 1308.

At decision block 1308, the LF conversion algorithm 118 may determine whether a given expression is encountered in the CIM rule expression. If the LF conversion algorithm 118 determines that a given expression is encountered (“yes” at decision block 1308), the process 1300 may proceed to block 1310. At block 1310, the LF conversion algorithm 118 may process the fact expression using the encountered given expression replacing the null given phrase from block 1302 as a given phrase. Following processing at block 1310, the process 1300 may proceed to block 1312. However, if the LF conversion algorithm 118 determines that a given expression is not encountered, (“no” at decision block 1308), the process 1300 may proceed directly to block 1312.

At block 1312, the LF conversion algorithm 118 may process the fact expression using the assumption expression as a matrix phrase.

At decision block 1314, the LF conversion algorithm 118 may determine whether a conditional expression is encountered in the CIM rule expression. If the LF conversion algorithm 118 determines that a conditional expression is encountered (“yes” at decision block 1314), the process 1300 may proceed to block 1316. At block 1316, the LF conversion algorithm 118 may process the fact expression using the conditional expression replacing the null conditional phrase from block 1302 as a conditional phrase. Following processing at block 1316, the process 1300 may proceed to block 1318. However, if the LF conversion algorithm 118 determines that a conditional expression is not encountered (“no” at decision block 1314), the process 1300 may proceed directly to block 1318.

At block 1318, the LF conversion algorithm 118 may assemble at least a portion of the semantically non-ambiguous LF syntax tree using any encountered event phrase, given phrase, matrix phrase, and conditional phrase. The assembly portion may constitute the derived result. At block 1320, the LF conversion algorithm 118 may return the derived result as part of a semantically non-ambiguous LF syntax tree.

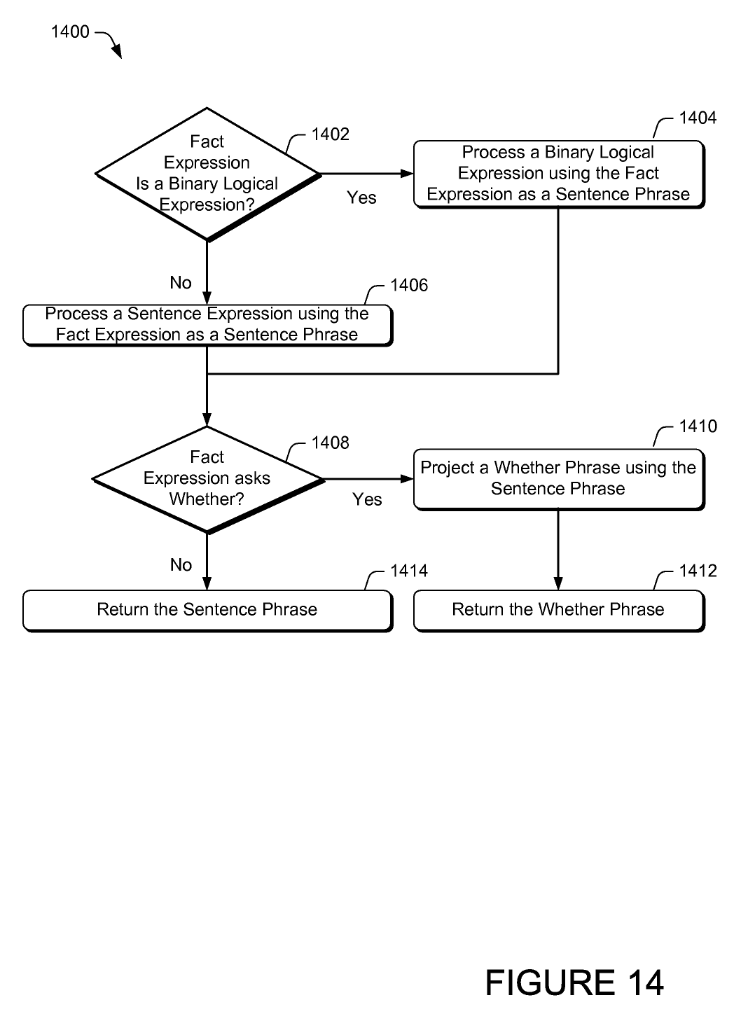

FIG. 14 is a flow diagram illustrating an exemplary process for processing a fact expression in a Computational Independent Model (CIM) rule expression in accordance with various embodiments. Exemplary process 1400 may further illustrate various blocks of processes 1000-1300.

At block 1402, the LF conversion algorithm 118 may determine whether a fact expression encountered in the CIM rule expression is a binary logical expression. If the LF conversion algorithm 118 determines that the fact expression is a binary expression (“yes” at decision block 1402), the process 1400 may proceed to block 1404. At block 1404, the LF conversion algorithm 118 may process the binary logical expression using the fact expression as a sentence phrase. Following processing at block 1404, the process 1400 may proceed to block 1408. However, if the LF conversion algorithm 118 determines that a binary logical expression is not encountered, (“no” at decision block 1402), the process 1400 may proceed directly to block 1406. At block 1406, the LF conversion algorithm 118 may process the sentence expression using the fact expression as a sentence phrase.

At decision block 1408, the LF conversion algorithm 118 may determine whether a fact expression asks whether. If the LF conversion algorithm 118 determines that the fact expression asks whether (“yes” at decision block 1408), the process 1400 may proceed to block 1410. At block 1410, the LF conversion algorithm 118 may project as a whether phrase using the sentence phrase. Following projection at 1410, the process 1400 may proceed to block 1412.

At block 1412, the LF conversion algorithm 118 may return as a derived result the whether phrase. In various embodiments, the derived result may be integrated into a semantically non-ambiguous LF syntax tree.

Returning to decision block 1408, if the LF conversion algorithm 118 determines that the fact expression does not ask whether (“no” at decision block 1408), the process 1400 may proceed to block 1414. At block 1414, the LF conversion algorithm 118 may return as a derived result the sentence phrase. In various embodiments, the derived result may be integrated into a semantically non-ambiguous LF syntax tree.

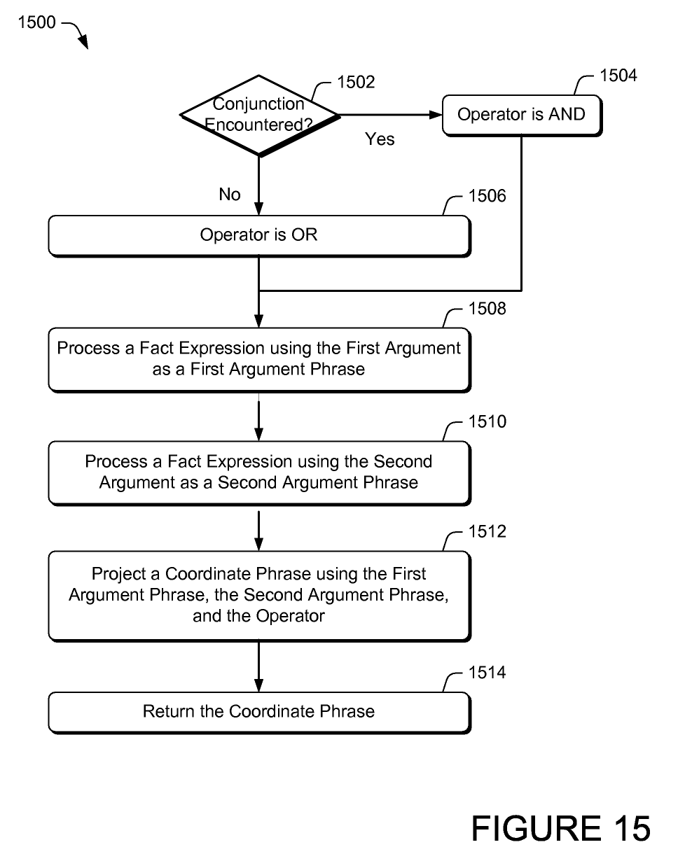

FIG. 15 is a flow diagram illustrating an exemplary process for processing a binary logical expression in a Computational Independent Model (CIM) rule expression in accordance with various embodiments. Exemplary process 1500 may further illustrate block 1404 of the exemplary process 1400.

At block 1502, the LF conversion algorithm 118 may determine whether a conjunction of a CIM binary logical expression is encountered. If the LF conversion algorithm 118 determines that a conjunction is encountered (“yes” at decision block 1504), the process 1500 may proceed to block 1504. At block 1504, the LF conversion algorithm 118 may determined that an operator of the CIM binary logical expression is AND. Following determination at block 1504, the process 1500 may proceed to block 1508. However, if the LF conversion algorithm 118 determines that a conjunction is not encountered (“no” at decision block 1502), the process 1500 may proceed directly to block 1506. At block 1506, the LF conversion algorithm 118 may determine that an operator of the CIM binary logical expression is OR. Following determination at block 1506, the process 1500 may proceed to block 1508.

At block 1508, the LF conversion algorithm 118 may process a fact expression using the first argument of the binary logical expression as a first argument phrase. At block 1510, the LF conversion algorithm 118 may process a fact expression using the second argument of the binary logical expression as a second argument phrase. At block 1512, the LF conversion algorithm 118 may project a coordinate phrase, where the coordinate phrase may be projected using the first argument phrase, the second argument phrase, and the determined operator.

At block 1514, the LF conversion algorithm 118 may return as a derived result the coordinate phrase. In various embodiments, the derived result may be integrated into a semantically non-ambiguous LF syntax tree.

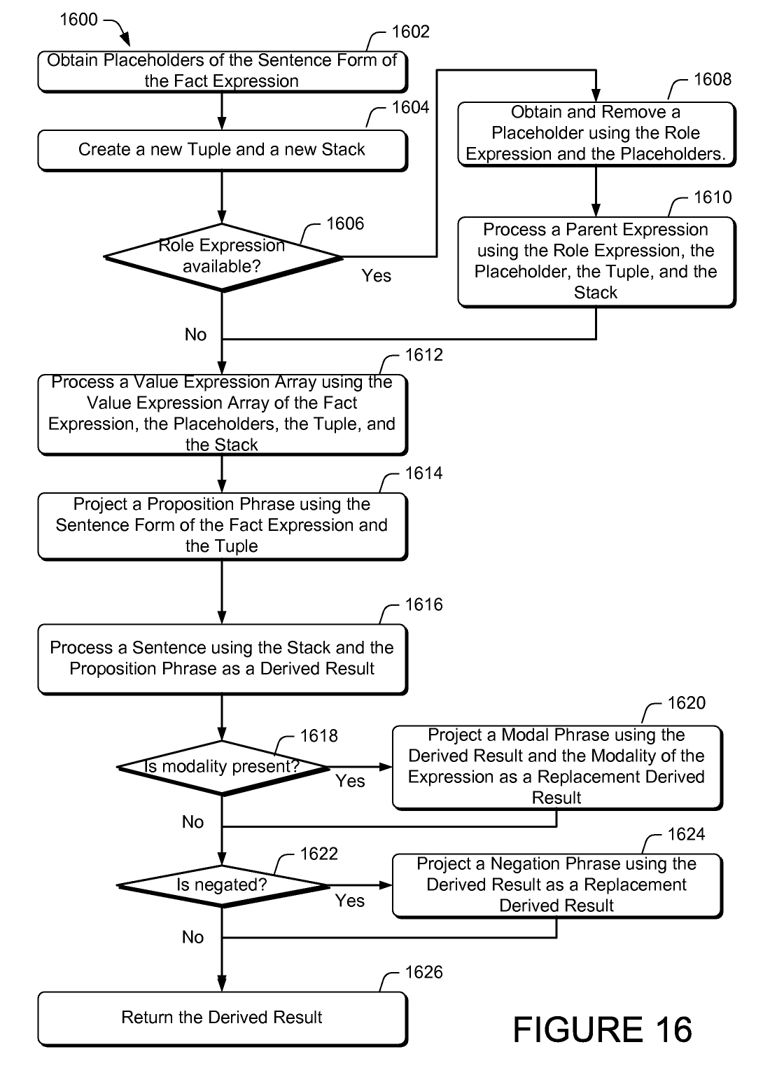

FIG. 16 is a flow diagram illustrating an exemplary process for processing a sentence expression in a Computational Independent Model (CIM) rule in accordance with various embodiments. Exemplary process 1600 may further illustrate block 1406 of the exemplary process 1400. Exemplary process 1600 may also further illustrate block 1806 of the exemplary process 1800.

At block 1602, the LF conversion algorithm 118 may obtain placeholders of a sentence form of a CIM fact expression. At block 1604, the LF conversion algorithm 118 may create a new tuple and create a new stack.

At block 1606, the LF conversion algorithm 118 may determine whether a role expression is available. If the LF conversion algorithm 118 determines that the role expression is available (“yes” at decision block 1402), the process 1600 may proceed to block 1608. At block 1608, the LF conversion algorithm 118 may obtain and remove a placeholder using the role expression and the placeholders. At block 1610, the LF conversion algorithm 118 may process a parent expression. In various embodiments, the processing of the parent expression may be performed using the role expression, the obtained placeholder, the created tuple, and the created stack. Following the processing at block 1610, the process 1600 may proceed to block 1612.

However, if LF conversion algorithm 118 determines that the role expression is not available (“no” at decision block 1606), the process 1600 may proceed to block 1612.

At block 1612, the LF conversion algorithm 118 may process a value expression array of the CIM fact expression. In various embodiments, the process of the value expression may be performed using the value expression array of the CIM fact expression, the placeholders of the fact expression, and the created tuple and created stack.

At block 1614, the LF conversion algorithm 118 may project a proposition phrase using the sentence from of the CIM fact expression and the created tuple. At block 1616, the LF conversion algorithm 118 may assemble a sentence as a derived result. In various embodiments, the sentence may be assembled using the created stack, and the projected propositional phrase.

At block 1618, the LF conversion algorithm may determine whether a modality is present in the CIM fact expression. If the LF conversion algorithm 118 determines that a modality is present (“yes” at decision block 1618), the process 1600 may proceed to block 1620. At block 1620, the LF conversion algorithm 118 may project a modal phrase as a replacement derived result. In various embodiments, the modal phrase may be projected using the derived result and the modality of the fact expression. Following the projection at block 1620, the process 1600 may proceed to decision block 1622.

However, if the LF conversion algorithm 118 determines that no modality is present (“no” at decision block 1618), the process 1600 may proceed directly to block 1622.

At decision block 1622, the LF conversion algorithm 118 may determine whether the assembled sentence is negated. If the LF conversion algorithm 118 determines that the assembled sentence is negative (“yes” at decision block 1622), the process 1600 may proceed to block 1624. At block 1624, the LF conversion algorithm 118 may project a negation phrase as a replacement derived result. In various embodiments, the negation phrase may be projected using the derived result. Following the projection at block 1624, the process 1600 may proceed to 1626.

However, if the LF conversion algorithm 118 determines that the assembled sentence is not negated (“no” at decision block 1618), the process 1600 may proceed directly to block 1626.

At block 1626, the LF conversion algorithm 118 may return the derived result as part of a semantically non-ambiguous LF syntax tree.

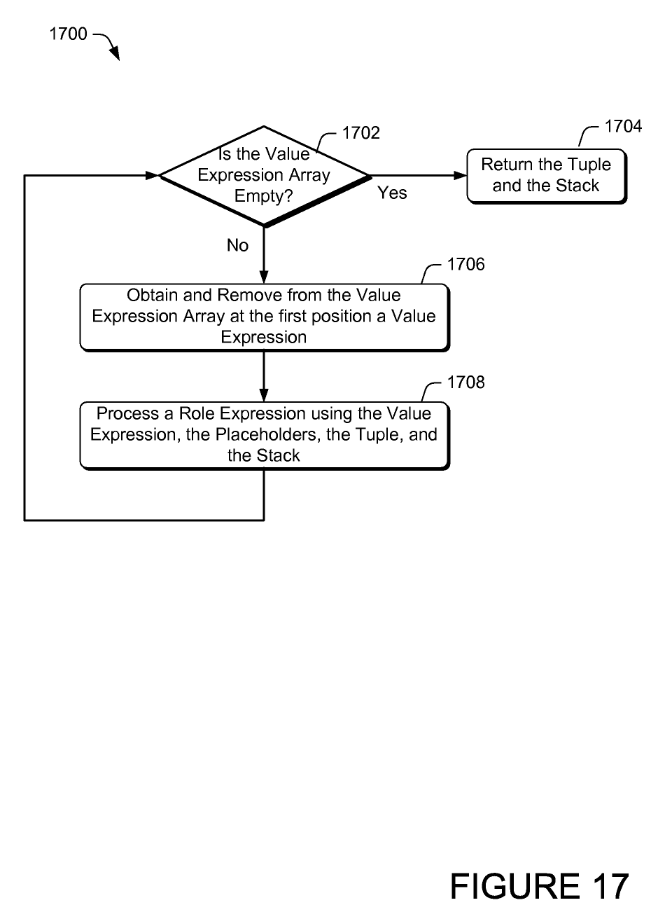

FIG. 17 is a flow diagram illustrating an exemplary process for processing value expression arrays in a Computational Independent Model (CIM) fact expression in accordance with various embodiments. Exemplary process 1700 may also further illustrate block 1612 of the exemplary process 1600.

At block 1702, the LF conversion algorithm 118 may determine whether the value expression array of a CIM fact expression is empty. If the LF conversion algorithm 118 determines that the variable is empty (“yes” at decision block 1702), the process 1700 may proceed to block 1704. At block 1704, the LF conversion algorithm 118 may return the tuple and the stack, such as the tuple and the stack referenced in exemplary process 1600 and illustrated in block 1604.

However, if the LF conversion algorithm 118 determines that the variable is not empty (“no” at decision block 1702), the process 1700 may proceed to block 1706. At block 1706, the LF conversion algorithm 118 may obtain and remove a first value expression using the value expression array.

At block 1708, the LF conversion algorithm 118 may process a role expression. In various embodiments, the processing may be performed using the first value expression, the placeholders, such as the placeholders referenced in exemplary process 1600 and illustrated in block 1612, the tuple, and the stack. Following processing at block 1708, the process 1700 may loop back to 1702 until the value expression array is empty.

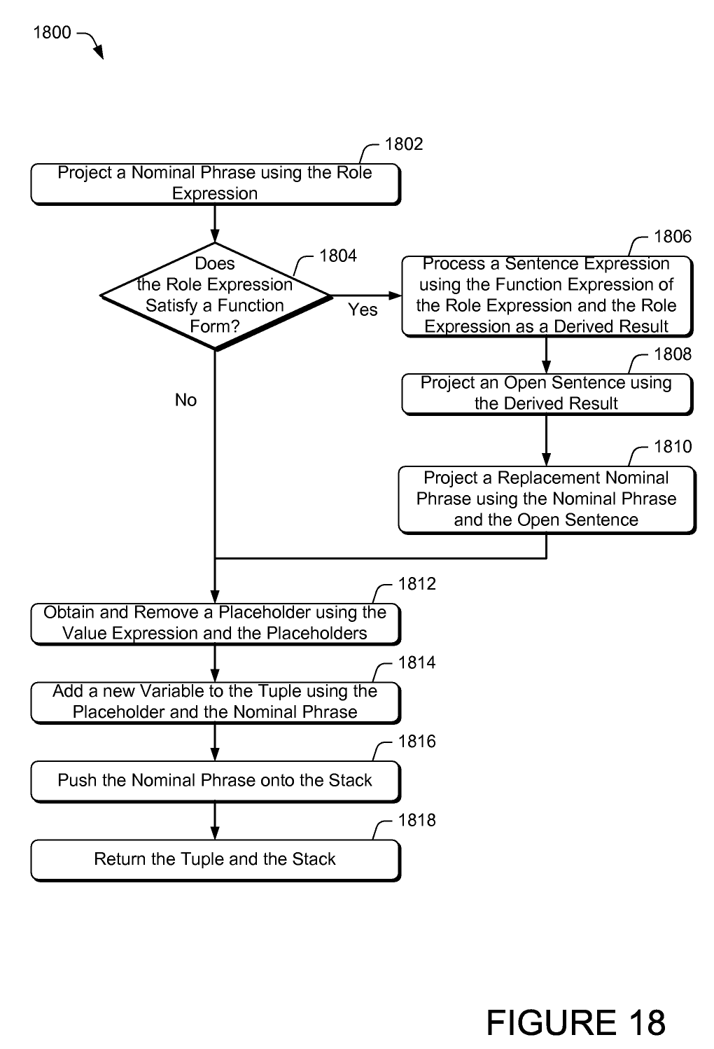

FIG. 18 is a flow diagram illustrating an exemplary process for processing a role expression in a Computational Independent Model (CIM) value expression using a value expression (or a role expression) in accordance with various embodiments. Exemplary process 1800 may further illustrate block 1708 of the exemplary process 1700.

At block 1802, the LF conversion algorithm 118 may project a nominal phrase using a value expression. At decision block 1804, the LF conversion algorithm 118 may determined whether the value expression satisfies a function form. If the LF conversion algorithm 118 determines that the value expression satisfies a function form (“yes” at decision block 1804), the process 1800 may proceed to block 1806. At block 1806, the LF conversion algorithm 118 may process a sentence expression. In various embodiments, the LF conversion algorithm 118 may process the sentence expression using a function expression and the value expression to produce a derived result. At block 1808, the LF conversion algorithm 118 may project an open sentence using the derived result. At block 1810, the LF conversion algorithm 118 may assemble a nominal phrase. In various embodiments, the nominal phrase may be assembled using the nominal phrase projected at block 1802 and/or the open sentence. Following the assembly at block 1810, the process 1800 may proceed to block 1812.

However, if the LF conversion algorithm 118 determines that the verb expression does not satisfy a function form (“no” at decision block 1804), the process 1800 may proceed directly to block 1812.

At block 1812, the LF conversion algorithm 118 may obtain and remove a placeholder using the value expression and the placeholders, such as the placeholders referenced in exemplary process 1700 and illustrated by block 1708.

At block 1814, the LF conversion algorithm 118 may add a new variable to the tuple, such as the tuple referenced in exemplary process 1700 illustrated by block 1708, using the placeholder and the nominal phrase. At block 1816, the LF conversion algorithm 118 may push the nominal phrase onto the stack, such as the stack referenced in exemplary process 1700 illustrated by block 1708. At block 1818, the LF conversion algorithm 118 may return the tuple and the stack.

### Exemplary Computing Environment

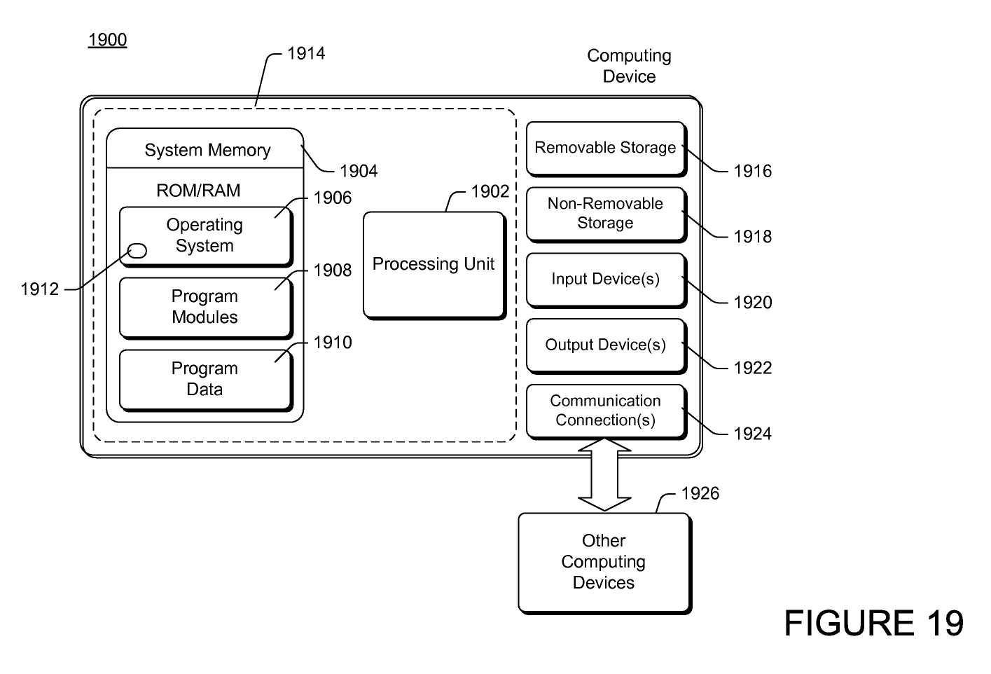

FIG. 19 illustrates a representative computing device 1900 that may be used to implement the selective networked resource access techniques and mechanisms described herein. For example, the logical form (LF) transformer 102 (FIG. 1) may be implemented on the representative computing device 1900. However, it will readily be appreciated that the various embodiments of the selective networked resource techniques and mechanisms may be implemented in other computing devices, systems, and environments. The computing device 1900 shown in FIG. 19 is only one example of a computing device, and is not intended to suggest any limitation as to the scope of use or functionality of the computer and network architectures. Neither should the computing device 1900 be interpreted as having any dependency or requirement relating to any one or combination of components illustrated in the example computing device.

In a very basic configuration, computing device 1900 typically includes at least one processing unit 1902 and system memory 1904. Depending on the exact configuration and type of computing device, system memory 1904 may be volatile (such as RAM), non-volatile (such as ROM, flash memory, etc.) or some combination of the two. System memory 1904 typically includes an operating system 1906, one or more program modules 1908, and may include program data 1910. The operating system 1906 includes a component-based framework 1912 that supports components (including properties and events), objects, inheritance, polymorphism, reflection, and provides an object-oriented component-based application programming interface (API), such as, but by no means limited to, that of the .NET™ Framework manufactured by the Microsoft Corporation, Redmond, Wash. The device 1900 is of a very basic configuration demarcated by a dashed line 1914. Again, a terminal may have fewer components but will interact with a computing device that may have such a basic configuration.

Computing device 1900 may have additional features or functionality. For example, computing device 1900 may also include additional data storage devices (removable and/or non-removable) such as, for example, magnetic disks, optical disks, or tape. Such additional storage is illustrated in FIG. 19 by removable storage 1916 and non-removable storage 1918. Computer storage media may include volatile and nonvolatile, removable and non-removable media implemented in any method or technology for storage of information, such as computer readable instructions, data structures, program modules, or other data. System memory 1904, removable storage 1916 and non-removable storage 1918 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1900. Any such computer storage media may be part of device 1900. Computing device 1900 may also have input device(s) 1920 such as keyboard, mouse, pen, voice input device, touch input device, etc. Output device(s) 1922 such as a display, speakers, printer, etc. may also be included. These devices are well known in the art and are not discussed at length here.

Computing device 1900 may also contain communication connections 1924 that allow the device to communicate with other computing devices 1926, such as over a network. These networks may include wired networks as well as wireless networks. Communication connections 1924 are some examples of communication media. Communication media may typically be embodied by computer readable instructions, data structures, program modules, etc.

It is appreciated that the illustrated computing device 1900 is only one example of a suitable device and is not intended to suggest any limitation as to the scope of use or functionality of the various embodiments described. Other well-known computing devices, systems, environments and/or configurations that may be suitable for use with the embodiments include, but are not limited to personal computers, server computers, hand-held or laptop devices, multiprocessor systems, microprocessor-base systems, set top boxes, game consoles, programmable consumer electronics, network PCs, minicomputers, mainframe computers, distributed computing environments that include any of the above systems or devices, and/or the like.

The conversion of Computational Independent Model (CIM) rule expressions into corresponding semantically non-ambiguous LF syntax trees may serve to ensure that anaphoric references in the rules expressions are properly resolved and that the rule expressions are semantically non-ambiguous. Accordingly, when the CIM rule expressions are automatically translated into computer code via the processing of the semantically non-ambiguous LF syntax trees, logical errors or bugs in the product computer code may be eliminated or reduced. Thus, embodiments in accordance with this disclosure may ensure that efficient and error-free generation of software applications from the CIM rule expressions.

### CONCLUSION

In closing, although the various embodiments have been described in language specific to structural features and/or methodological acts, it is to be understood that the subject matter defined in the appended representations is not necessarily limited to the specific features or acts described. Rather, the specific features and acts are disclosed as exemplary forms of implementing the claimed subject matter.

1. A method, comprising:
creating a logical form (LF) model that provides a semantically non-ambiguous LF syntax tree from a rule expression, the semantically non-ambiguous LF syntax tree representing one or more anaphoric references in the rule expression;
analyzing a sentential structure of a rule expression for a plurality of clauses that include at least one expression and at least one rule using the LF model, the plurality of clauses including a plurality of conditional clauses;
translating the rule expression into a semantically non-ambiguous LF syntax tree based on the LF model, the translating includes adjoining the plurality of conditional clauses by resolving one or more anaphoric references; and
presenting the semantically non-ambiguous LF syntax tree.

2. The method of claim 1, wherein the rule expression includes a Computational Independent Model (CIM) rule expression.

3. The method of claim 1, wherein the semantically non-ambiguous LF syntax tree includes at least one phrase marker, the at least one phrase marker being one of a sentential phrase marker or a projection phrase marker.

4. The method of claim 1, wherein the semantically non-ambiguous LF syntax tree includes a plurality of projections, and wherein at least two of the projections are linked by a variable, and each projection including one or more tuples.

5. The method of claim 1, wherein the analyzing the rule expression includes recursively descend through the sentential structure of the rule expression.

6. The method of claim 1, wherein the plurality of clauses further includes one of an event clause, a given clause, and a main clause.

7. The method of claim 1, wherein the adjoining the plurality of the conditional clauses includes using an if phrase operator to joining the coordinate phrase markers of two conditional clauses, and reversing an order of two conditional clauses

8. A computer readable medium storing computer-executable instructions that, when executed, cause one or more processors to perform acts comprising:
analyzing a sentential structure of a Computational Independent Model (CIM) rule expression for a plurality of clauses that include at least one expression and at least one rule;
constructing a semantically non-ambiguous LF syntax tree from the CIM rule expression using a logical form (LF) model; and
presenting the semantically non-ambiguous LF syntax tree.

9. The computer readable medium of claim 8, wherein the at least one rule includes one of an assertion rule, a constraint rule, a declaration rule, and a default rule, and wherein the at least one expression includes one of an event expression, a role expression, a value expression, a fact expression, and sentence expression.

10. The computer readable medium of claim 9, wherein each of the assertion rule, default rule, and declaration rule includes at least one of an event clause, a given clause, a main clause, or a conditional clause, and the constructing includes creating a phrase marker for one of an event clause, a given clause, a main clause, or a conditional clause.

11. The computer readable medium of claim 9, wherein the constructing includes creating a modal phrase marker for one of a permission modal operator, an obligation modal operator, or a prohibition modal operator of the constraint rule.

12. The computer readable medium of claim 8, wherein the plurality of rules includes at least one rule that comprises multiple clauses, and wherein the providing includes adjoining the multiple clauses into coordinate phrase markers.

13. The computer readable medium of claim 12, where adjoining the multiple clauses includes using an upon phrase operator to join the coordinate phrase markers of multiple event clauses, and using a given phrase operator to join the coordinate phrase markers of multiple given clauses.

14. The computer readable medium of claim 12, wherein adjoining the multiple clauses includes using an if phrase operator to joining the coordinate phrase markers of two conditional clauses, and reversing an order of two conditional clauses.

15. The computer readable medium of claim 9, wherein the constructing includes creating an event phrase marker that projects an event projection for the event expression.

16. The computer readable medium of claim 9, wherein the constructing includes consuming role expression to create tuples for the fact expression to range over.

17. The computer readable medium of claim 9, wherein the constructing includes projecting a fact type of the sentence expression as a propositional phrase marker and projecting an n-tuple of variables.

18. The computer readable medium of claim 9, wherein the value expression includes one of a quantifier expression, a literal expression, an instance expression, a mathematical expression, or a fact value expression, and wherein the constructing includes one of project a literal expression node for the literal expression that represents a literal value and binding the literal value to a variable, project a constant instance that represents a name value and binding the name value to the variable, decomposing the mathematical expression into an expression tree that surfaces the mathematical computation as an expression value and binding the expression value to the variable, or decomposing a quantifier expression by determining a relevant quantifier type and projecting a quantifier as one of cardinal or universal, and binding the quantifier to the variable.

19. A transformer, comprising:
an input component that receives a Computational Independent Model (CIM) rule expression, the CIM rule expression including at least one anaphoric reference, the at least one anaphoric reference being a pronominal link between an antecedent reference and one of a definite description or a pronoun;
a logical form (LF) model that resolves the at least one anaphoric reference into a semantically disambiguated representation;
an algorithm that generates a semantically non-ambiguous LF syntax tree from the CIM rule expression based on the LF model, the semantically non-ambiguous LF syntax tree including the semantically disambiguated representation; and
an output component that present the semantically non-ambiguous LF syntax tree.

20. The transformer of claim 18, wherein the semantically non-ambiguous LF syntax tree includes at least one of one or more phrase markers, one or more projections, one or more quantifiers, one or more variables, and one or more tuples.
